(19) United States
(12) Patent Application Publication
(10) Pub. No.: US 2025/0376969 A1
(43) Pub. Date: Dec. 11, 2025

(54) NATURAL RUN-OF-THE-RIVER HYDRO POWER GENERATION SYSTEM FOR PRODUCING CLEAN ENERGY

(71) Applicant: W.L. French Hydropower Holdings LLC, Chelmsford, MA (US)

(72) Inventor: William L. French, SR., Lexington, MA (US)

(21) Appl. No.: 18/962,402

(22) Filed: Nov. 27, 2024

Related U.S. Application Data
(60) Provisional application No. 63/658,430, filed on Jun. 10, 2024.
(60) Provisional application No. 63/693,175, filed on Sep. 10, 2024.
(60) Provisional application No. 63/701,484, filed on Sep. 30, 2024.
(60) Provisional application No. 63/712,974, filed on Oct. 28, 2024.

(51) Int. Cl. F03B 17/06; A01K 61/00; A01M 29/30

(52) U.S. Cl. CPC F03B 17/06

(57) ABSTRACT

A hydro power generation system may include a powerhouse and an entrance region structure. The powerhouse may include an intake port, a draft port, and a power generator disposed therebetween, the power generator configured to generate electrical power. The entrance region structure may be coupled to the powerhouse and define a portion of a boundary of an entrance region and the natural run-of-the-river portion of a waterway. The entrance region may be distinct from the natural run-of-the-river portion of the waterway and fluidically adjacent to the intake port.

### RELATED APPLICATIONS

This application claims the benefit of U.S. Provisional Application No. 63/693,175, filed on Sep. 10, 2024. This application claims the benefit of U.S. Provisional Application No. 63/658,430, filed on Jun. 10, 2024.

This application claims the benefit of U.S. Provisional Application No. 63/712,974, filed on Oct. 28, 2024. This application claims the benefit of U.S. Provisional Application No. 63/701,484, filed on Sep. 30, 2024.

The entire teachings of the above applications are incorporated herein by reference.

### BACKGROUND

Hydroelectric dams and powerhouses are used to convert kinetic energy provided by a flowing fluid into electrical power for a local area. Powerhouses and/or dams that obstruct a substantial portion or all of a waterway have a destructive impact on aquatic life and an adverse impact on other uses of the waterway, for example shipping and recreation.

### SUMMARY

A hydro power generation system may include a powerhouse and an entrance region structure. The powerhouse may include an intake port, a draft port, and a power generator disposed therebetween, the power generator configured to generate electrical power as a function of fluid flow between the intake port and draft port, the powerhouse, during operation of the power generator, in fluidic communication with a natural run-of-the-river portion of a waterway via the intake port and the draft port, with the fluid flow therebetween distinct from the natural run-of-the-river portion of the waterway. The entrance region structure may be coupled to the powerhouse and define a portion of a boundary of an entrance region and the natural run-of-the-river portion of the waterway, the entrance region being distinct from the natural run-of-the-river portion of the waterway and fluidically adjacent to the intake port.

In some example embodiments, the power generation system further comprises an entrance region operational support system configured to enable aquatic life or fluid volume in the entrance region to be managed.

In some example embodiments, the powerhouse is one or multiple powerhouses and the entrance region operational support system coordinates communication between the multiple powerhouses.

In some example embodiments, the entrance region operational support system is controlled remotely.

In some example embodiments, the entrance region operational support system comprises an attraction system configured attract aquatic life in the waterway toward the natural run-of-the-river portion of the waterway.

In some example embodiments, at least one of the at least one attraction system comprises a gas infusion system.

In some example embodiments, the gas infusion system is configured to increase the amount of oxygen in the natural run-of-the-river portion of the waterway or at an opposing side of the natural run-of-the-river waterway from a location of the entrance region of the powerhouse.

In some example embodiments, the at least one attraction system is configured to decrease the amount of nitrogen and/or trace gases in the natural run-of-the-river portion of the waterway or at an opposing side of the natural run-of-the-river waterway from a location of an entrance region of the powerhouse.

In some example embodiments, the powerhouse is arranged at one side of the waterway and the attraction system is arranged at an opposing side of the waterway such that the natural run-of-the-river portion of the waterway is between the powerhouse and the attraction system.

In some example embodiments, the attraction system is positioned upstream from an entrance region to the powerhouse.

In some example embodiments, the attraction system is deployed within 500 feet of the powerhouse.

In some example embodiments, the entrance region operational support system comprises further comprises at least one deterrence system known to deter aquatic life and located at least a portion of or upstream of a perimeter of the entrance region to the powerhouse.

In some example embodiments, the deterrence system is configured to be selectively opened and closed or activated and deactivated.

In some example embodiments, the entrance region structure is an entrance region direction wall that defines at least a portion of a perimeter of the entrance region, the entrance region direction wall separating the entrance region from the natural run-of-the river portion of the waterway.

In some example embodiments, the entrance region direction wall comprises at least two precast segments interconnected to each other.

In some example embodiments, the power generation system further comprises at least one flood control gate mounted at the entrance region direction wall.

In some example embodiments, the entrance region direction wall defines a port configured to allow access from the entrance region to the natural run-of-the-river portion of the waterway.

In some example embodiments, the power generation system further comprises a port cover coupled to the entrance region direction wall and arranged to restrict fluidic access through the port in a selectable manner.

In some example embodiments, the entrance region has an opening at least partially defined by the entrance region direction wall.

In some example embodiments, the power generation system further comprises an exit region direction wall that defines at least a portion of a perimeter of an exit region from the powerhouse.

In some example embodiments, the entrance region direction wall comprises an adjustable intake arm.

In some example embodiments, the entrance region operational support system is configured to control the adjustable intake arm.

In some example embodiments, the power generation system further comprises a water height sensor configured to communicate with the entrance region operational support system, the entrance region operational support system being configured to control the adjustable intake arm in response to signals from the water height sensor.

In some example embodiments, the adjustable intake arm is coupled to a track and is constructed and arranged to be controllably moved along the track, thereby adjusting access to or flow of fluid into the entrance region.

In some example embodiments, the adjustable intake arm comprises at least two precast segments interconnected to each other.

In some example embodiments, a river-facing side of the entrance region support structure and a river-facing side of the powerhouse are composed of precast segments.

In some example embodiments, at an intersection between the powerhouse and the entrance region support structure, a precast segment from the powerhouse is adjacent to a precast segment of the entrance region support structure.

In some example embodiments, the powerhouse comprises multiple intake ports and respective multiple draft ports and further comprises at least one intake control gate configured to restrict access to a corresponding intake port.

In some example embodiments, the powerhouse comprises at least two precast segments interconnected to each other.

In some example embodiments, the powerhouse is positioned in the middle of the waterway, and the natural run-of-the-river portion is between the powerhouse and at least one edge of the waterway.

A method of operating a hydro power generation system may include: monitoring the levels of fluid volume at an entrance region of a powerhouse, the entrance region being distinct from a natural run-of-the-river portion of a waterway, the entrance region being upstream of and fluidically adjacent to an intake port of the powerhouse; and adjusting one or more elements of an entrance region operational support system in response to the level of fluid volume in the entrance region being at or above a fluid threshold level.

In some example embodiments, at least two of the one or more elements of the entrance region operational support system are associated with different powerhouses.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a top schematic view of an example embodiment of a power generation system.

FIG. 1B is a perspective view of the power generation system of FIG. 1A.

FIG. 1C is a perspective view of the power generation system of FIG. 1A.

FIG. 1D shows an example embodiment of an adjustable intake arm coupled to a direction wall.

FIG. 1E shows side view of an example embodiment of a coupling component of an adjustable intake arm and a track.

FIG. 2 is a top schematic view of an example embodiment of a power generation system with a deterrence system near the entrance region.

FIG. 3 is a top schematic view of an example embodiment of a power generation system with an access control gate near the entrance region.

FIG. 4A shows an example embodiment of a pivotable access control gate coupled to direction walls.

FIG. 4B shows side view of an example embodiment of a coupling component of an access control gate and a track.

FIG. 5 is a top schematic view of an example embodiment of a power generation system.

FIG. 6A shows a perspective of an example embodiment of a cutoff wall coupled to rock bolts.

FIG. 6B shows a close-up view of the cutoff wall of FIG. 6A.

FIG. 7A shows a perspective view of an example embodiment of a cutoff wall coupled to multiple rock bolts.

FIG. 7B shows a perspective view of a cutoff wall coupled to multiple cleats, rock bolts, and diffusers, the diffusers being coupled to a downstream side of the cutoff wall.

FIG. 8 shows an example embodiment of a method of operating a power generation system.

FIG. 9 shows an example method of operating a power generation system.

FIG. 10 shows an example method of operating a power generation system.

FIG. 11 shows an example embodiment of an entrance region operational support system.

FIG. 12 shows an example embodiment of a power generation system in which the entrance region is coupled to the powerhouse using fluid conduits.

FIG. 13 shows a top view an example embodiment of a power generation system in which the entrance region is coupled to the powerhouse using fluid conduits.

FIG. 14 shows an example embodiment of an entrance region of a power generation system.

FIG. 15 shows an example embodiment of a power generation system and shows an attraction system.

FIG. 16 shows an example embodiment of a power generation system with two fluid conduits.

FIG. 17A shows an example embodiment of a powerhouse of a power generation system.

FIG. 17B shows an example embodiment of a powerhouse and two draft ports.

FIG. 18 shows an example embodiment of a power generation system.

FIG. 19 shows an example embodiment of a power generation system.

FIG. 20 shows an example embodiment of a powerhouse of a power generation system.

FIG. 21 shows an example embodiment of an entrance to a powerhouse of a power generation system.

FIG. 22 shows an example embodiment of a powerhouse of a power generation system.

FIG. 23 shows an example embodiment of a powerhouse of a power generation system.

FIG. 24 shows an example embodiment of a powerhouse of a power generation system.

FIG. 25 shows an example embodiment of a powerhouse of a power generation system.

FIG. 26 shows an example embodiment of a ladder and flood control gates (also referred to as overflow gates).

FIG. 27 shows an example embodiment of a powerhouse with three intake bays.

FIG. 28 shows an overview of an example embodiment of a power generation system.

FIG. 29A shows an example embodiment of a powerhouse, an entrance region, and a variable intake arm, without fluid in the entrance region.

FIG. 29B shows an example embodiment of a powerhouse and an entrance region.

FIG. 30 shows an example embodiment of a power generation system that includes an attraction system, without fluid covering the attraction system.

FIG. 31 shows an example embodiment of a power generation system, without fluid adjacent to the powerhouse.

FIG. 32 shows an example embodiment of a power generation system, with fluid adjacent to the powerhouse.

FIG. 33A shows an example embodiment of an output region of a powerhouse and diverters (also referred to as diffusers), without fluid in the output region.

FIG. 33B shows an example embodiment of an output region of a powerhouse with fluid adjacent to the powerhouse.

FIG. 34 shows an example embodiment of an output region of a powerhouse with diverters, without fluid in the output region.

FIG. 35A shows an example embodiment of a power generation system from the intake side of the powerhouse.

FIG. 35B shows an example embodiment of a power generation system from the output side of the powerhouse.

FIG. 35C shows a top view of an example embodiment of a power generation system.

FIG. 36 shows an example embodiment of a power generation system.

### DETAILED DESCRIPTION

A description of example embodiments follows.

Systems and methods described herein allow for power generation while facilitating other uses of the waterway and reducing destructive impacts on aquatic life.

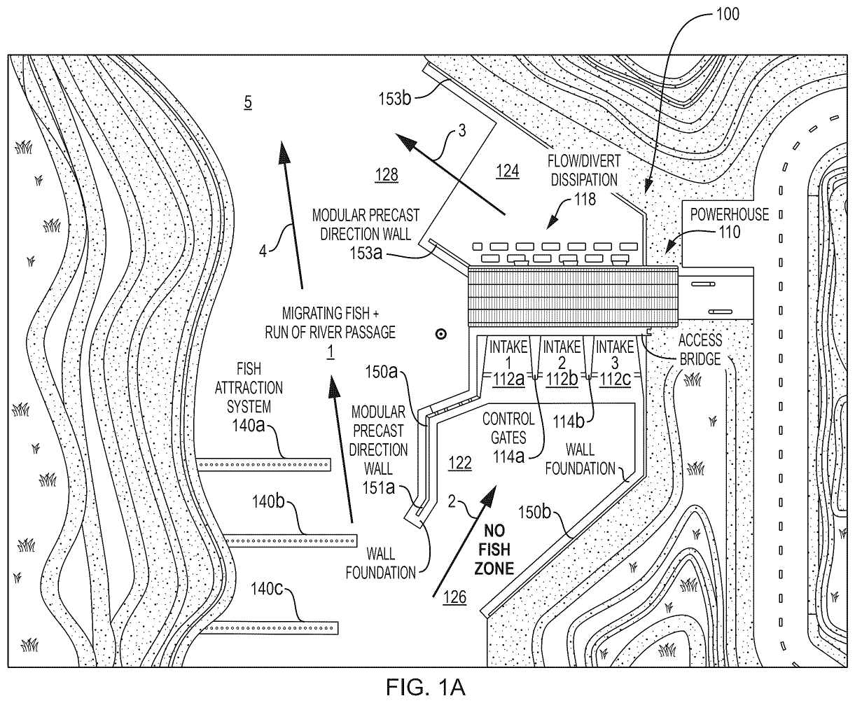

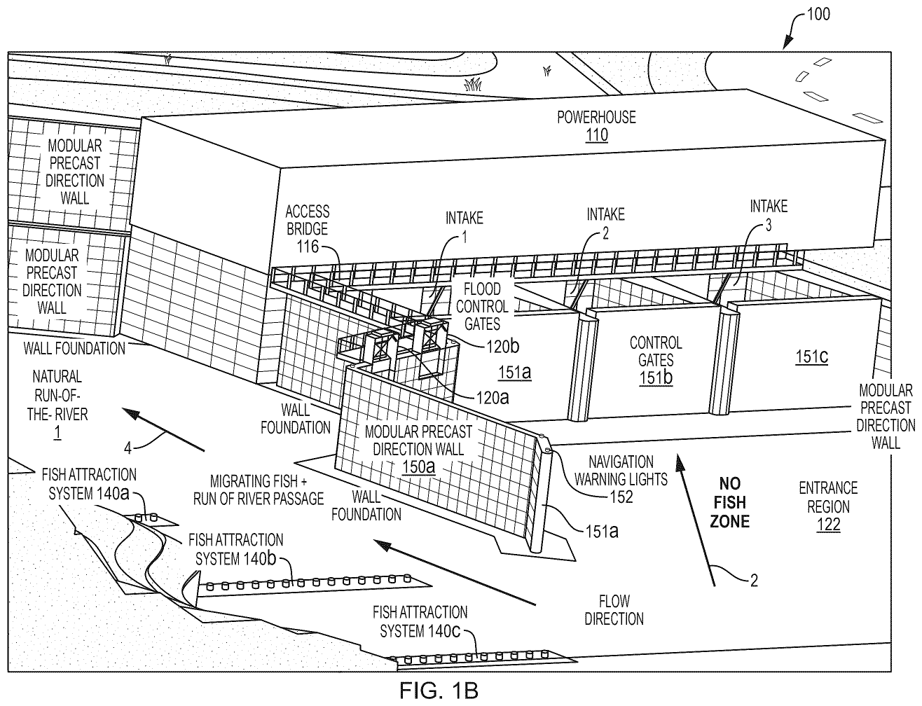

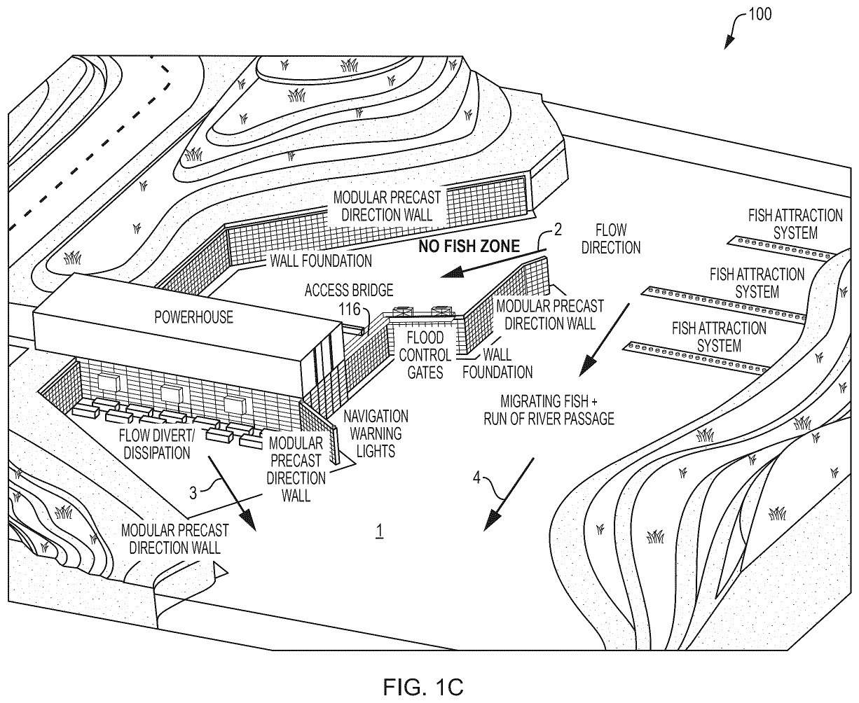

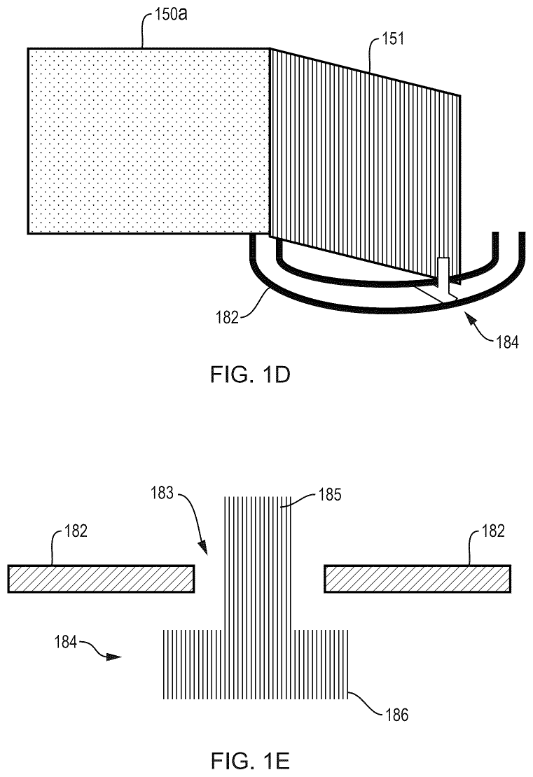

FIG. 1A is a top schematic view of an example embodiment of a power generation system 100, in accordance with aspects of inventive features. A hydro power generation system may include a powerhouse and an entrance region structure, with the entrance region structure including, for example, a direction wall, which may be formed with modular precast segments. The powerhouse may include an intake port, a draft port, and a power generator disposed therebetween, the power generator may be configured to generate electrical power as a function of fluid flow between the intake port and draft port.

During operation of the power generator, the powerhouse may be in fluidic communication with a natural run-of-the-river portion of a waterway via the intake port and the draft port, with the fluid flow therebetween distinct from the natural run-of-the-river portion of the waterway. The entrance region structure may be coupled to the powerhouse and define a portion of a boundary of an entrance region and the natural run-of-the river portion of the waterway, the entrance region being distinct from the natural run-of-the-river portion of the waterway and fluidically adjacent to the intake port.

In some example embodiments, the power generation system further comprises an entrance region operational support system 11 configured to enable aquatic life or fluid volume in the entrance region to be managed. In some example embodiments, the powerhouse is one or multiple powerhouses and the entrance region operational support system coordinates communication between the multiple powerhouses.

In some example embodiments, such as the one shown in FIG. 1A, the power generation system 100 may comprise a powerhouse 110 configured to generate electrical power; and at least one attraction system 140 configured to attract aquatic life. Aquatic creatures may be injured or killed if they enter a powerhouse. Attracting aquatic life away from a powerhouse reduces this destructive impact on aquatic life. The powerhouse may be located at a natural drop in a waterway or at a man-made drop.

A natural run-of-the-river hydro power generation system for producing clean energy may include a powerhouse 110 and, optionally, at least one attraction system 140. The powerhouse may include an intake port and a draft port configured to generate electrical power. The powerhouse may be in fluidic communication with a natural run-of-the-river portion 1 of a waterway 5 via the intake port and the draft port. The at least one attraction system 140 may be configured to attract aquatic life in the waterway 5 toward the natural run-of-the-river portion 1 of the waterway 5 (i.e., away from the powerhouse 110) so that the aquatic life doesn't enter the powerhouse 110.

In some example embodiments, such as the one shown in FIG. 1A, the powerhouse 110 is arranged at one side of a waterway 5 and the attraction system 140 is arranged at an opposing side of the waterway such that a portion of the waterway 5 is between the powerhouse 110 and the attraction system 140. In alternative embodiments, the powerhouse 110 and the attraction system 140 are arranged at the same side of a waterway 5. In some example embodiments, the attraction system 140 is positioned upstream from an entrance region 122 to the powerhouse 110. The attraction system 140 may be positioned at an opposing side of a waterway 5 relative to the entrance region 122 to the powerhouse 110.

In some example embodiments, fluid is configured to enter the powerhouse 110 from an upstream region. In some example embodiments, fluid is configured to exit the powerhouse 110 towards a downstream region. In FIG. 1A, a large red arrow indicates the direction 2 that fluid may take as it enters the powerhouse 110. A second large red arrow indicates the direction 3 that fluid may take as it exits the powerhouse 110. Two large black arrows indicate the natural run-of-the-river direction 4 of passage though the waterway 5. The natural run-of-the-river portion 1, is the portion of the waterway 5 that is naturally navigable (i.e., navigable and not passing through a human-made structure). In some example embodiments, such as the one shown in FIG. 1A, the natural run-of-the-river portion 1 of the waterway 5 is between the powerhouse 110 and the attraction system 140. In other words, ships, people, fish, etc. may pass between the powerhouse 110 and the attraction system 140. In some example embodiments, the natural run-of-the-river portion 1 overlaps the attraction system 140. In other words, ships, people, fish, etc. may pass over the attraction system 140.

The powerhouse 110 and the attraction system 140 may be arranged such that a portion of the waterway 5 is navigable for shipping. The powerhouse 110 and the attraction system 140 may be arranged such that a portion of the waterway 5 is navigable for recreational activities. In some example embodiments, the powerhouse 110 and the attraction system 140 are arranged such that less than one-quarter of the waterway 5 is navigable. In some example embodiments, the powerhouse 110 and the attraction system 140 are arranged such that at least one-quarter of the waterway 5 is navigable. In some example embodiments, the powerhouse 110 and the attraction system 140 are arranged such that between one-quarter and one-half of the waterway 5 is navigable. In some example embodiments, the powerhouse 110 and the attraction system 140 are arranged such that at least half of the waterway 5 is navigable. In some example embodiments, the powerhouse 110 and the attraction system 140 are arranged such that between one-half and three quarters of the waterway 5 is navigable. In some example embodiments, the powerhouse 110 and the attraction system 140 are arranged such that at least three-quarters of the waterway 5 is navigable. In some example embodiments, the powerhouse 110 and the attraction system 140 are arranged such that more than three-quarters of the waterway 5 is navigable.

In some example embodiments, the attraction system is located at or within 500 feet of a powerhouse. In some example embodiments, the attraction system is located more than 500 feet of a powerhouse.

The powerhouse 110 may comprise at least one power generation mechanism configured to generate electrical power. In some example embodiments, at least one of the power generation mechanisms may be a turbine. In some example embodiments, one or more power generation systems 100 at a powerhouse may be configured to generate approximately 20-80 MW of power. In alternative embodiments, the power generation system is configured to generate a different amount of power. In alternative embodiments, the power generation system may comprise more than one powerhouse.

A fluid, such as water, may be configured to enter the powerhouse 110 via one or more intake ports. In some example embodiments, the powerhouse 110 comprises one or more intake bays 112, each intake bay 112 corresponding to an intake port. In embodiments with more than one intake bay, such as the one shown in FIG. 1A, the intake bays 112 may be separated by dividers 114. In the embodiment shown in FIG. 1A, the powerhouse 110 comprises three intake bays 112a, 112b, 112c. In alternative embodiments, the powerhouse 110 comprises a different number of intake bays 112. In the embodiments shown in FIG. 1A, the powerhouse 110 comprises two dividers 114a, 114b. In alternative embodiments, the powerhouse 110 comprises a different number of dividers 114.

In some example embodiments a predetermined number of power generators may be fluidically coupled to each intake port. For example, each intake port may be fluidically coupled to one power generator. Alternatively, each intake port may be fluidically coupled to two power generators. Alternatively, each intake port may be fluidically coupled to a different number of power generators. In some example embodiments, different intake ports may be fluidically coupled to a different number of power generators. For example, a first intake port may be fluidically coupled to one power generator and a second intake port may be fluidically coupled to two power generators.

In some example embodiments, an intake port may not be fluidically coupled to a power generator. For example, some fluid paths through the powerhouse may not include a power generator so that water and/or aquatic life may pass through the powerhouse. In some example embodiments, such paths that do not include a power generator may include one or more elements described herein to facilitate the passage of aquatic life through the powerhouse. For example, an attraction system may be positioned in such a way as to attract aquatic life along a fluid path that does not pass near a power generator.

The entrance region operational support system may comprise at least one intake control gate 115 configured to restrict access to a corresponding intake port and/or intake bay. In the embodiment shown in FIG. 1A, the powerhouse 110 comprises three intake bays 112a, 112b, 112c and three corresponding intake control gates 115a, 115b, 115c (see FIG. 1B).

The power generation system 100 may further comprise at least one diffuser 118 configured to divert fluid flow or dissipate energy associated with fluid flow. The at least one diffuser 118 may be positioned at or near the entrance region 122 and/or exit region 124 of the powerhouse 110. In some example embodiments, the power generation system 100 does not comprise a diffuser 118. In the embodiment shown in FIG. 1A, a collection of diffusers 118 are located near the exit of the powerhouse 110. Additionally, or alternatively, one or more diffusers 118 may also be located near the entrance region 122 of the powerhouse 110.

In some example embodiments, the powerhouse 110 includes at least one precast segment. In some example embodiments, the powerhouse 110 is coupled to a riverbed using one or more rock bolts. In some example embodiments, the powerhouse 110 is coupled to a riverbed using one or more anchor bolts. In some example embodiments, the powerhouse 110 is coupled to the riverbed using means suitable for securing the position of the powerhouse.

The power generation system 100 may comprise at least one direction wall configured to direct the flow of fluid into or out of the powerhouse 110. In some example embodiments, such as the one shown in FIG. 1A, the power generation system 100 comprises at least one direction wall. In some example embodiments, at least one entrance region direction wall 150 at least partially defines a perimeter of an entrance region 122 to the powerhouse 110. In the embodiment shown in FIG. 1A, the power generation system 100 comprises two entrance region direction walls 150a, 150b, which partially define a perimeter of an entrance region 122 to the powerhouse 110. In alternative embodiments, the power generation system may comprise a different number of entrance region direction walls 150 that define a perimeter of an entrance region 122. In alternative embodiments, the power generation system may not comprise any entrance region direction walls 150 that define a perimeter of an entrance region 122.

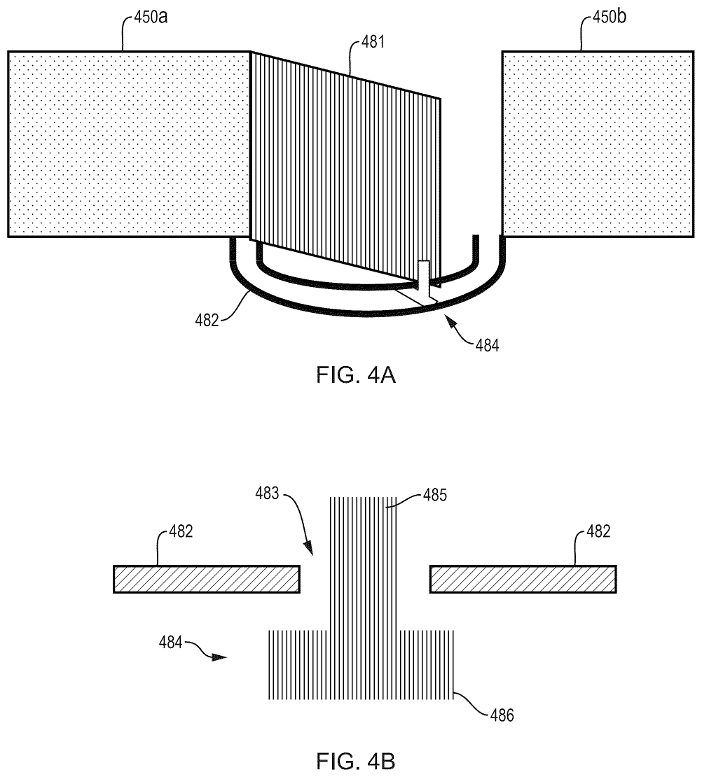

In some example embodiments, one or more or the direction walls may comprise one or more adjustable intake arm 151. The adjustable intake arm 151 may be configured pivot, slide, or move. An adjustable intake arm may assist with managing the amount of fluid and/or aquatic life in the entrance region 122. In some example embodiments, the adjustable intake arm 151 may comprise a lock configured to secure the position of the adjustable intake arm 151. In some example embodiments, the adjustable intake arm 151 may operate using a hydraulic mechanism. In some example embodiments, the adjustable intake arm 151 may comprise one or more of the features or characteristics described in connection with the access control gate or the pivotable access control gate (for example, see FIGS. 4A-4B). In some example embodiments, one or more direction wall may not include an adjustable intake arm. In some example embodiments, one or more direction wall may not include an adjustable intake arm, but it may include a portion that is oriented in a different direction than the rest of the direction wall.

In some example embodiments, the entrance region operational support system comprises at least one flood control gate 120. In some example embodiments, such as the one shown in FIG. 1B, the power generation system 100 comprises two flood control gates 120a, 120b (see FIG. 1B). In alternative embodiments, the power generation system 100 comprises a different number of flood control gates 120. In alternative embodiments, the power generation system 100 does not comprise any flood control gates. In some example embodiments, such as the one shown in FIG. 1B, at least one flood control gate 120 may be positioned at a direction wall, for example, an entrance region direction wall 150. In some example embodiments, at least one flood control gate 120 may be embedded in a direction wall, for example an entrance region direction wall 150. In some example embodiments, a flood control gate may be at the top of a direction wall, but the direction wall may be a different height than the walls shown in FIG. 1B.

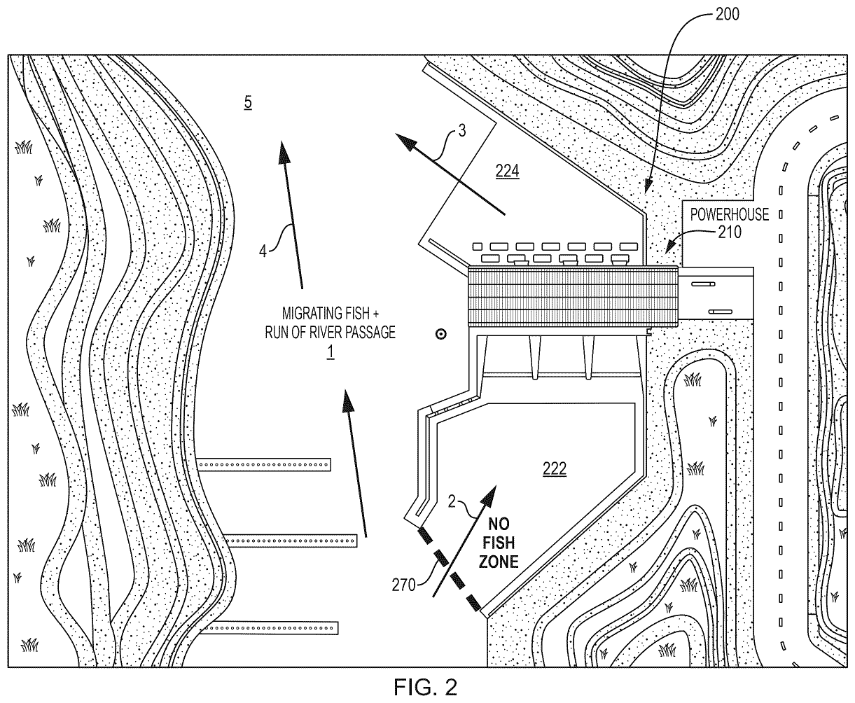

In some example embodiments, such as the one shown in FIG. 1A, the entrance region 122 has an upstream opening 126 defined by at least one entrance region direction wall 150. In the embodiment shown in FIG. 1A, the upstream opening 126 is defined by two entrance region direction walls 150a, 150b. In some example embodiments, a barrier or gate may fully or partially block the upstream opening 126 (see FIGS. 2-4).

In some example embodiments, such as the one shown in FIG. 1A, at least one exit region direction wall 153 at least partially defines a perimeter of an exit region 124 to the powerhouse 110. In the embodiment shown in FIG. 1A, the power generation system 100 comprises two exit region direction walls 153a, 153b, which partially define a perimeter of an exit region 124 from the powerhouse 110. In alternative embodiments, the power generation system may comprise a different number of exit region direction walls 153 that define a perimeter of an exit region 124. In alternative embodiments, the power generation system may not comprise any exit region direction walls 153 that define a perimeter of an exit region 124.

In some example embodiments, such as the one shown in FIG. 1A, the exit region 124 has a downstream opening 128 defined by at least one exit region direction wall 153. In the embodiment shown in FIG. 1A, the downstream opening 128 is defined by two direction walls 153a, 153b. In some example embodiments, a barrier or gate may fully or partially block the downstream opening 128.

In some example embodiments, at least one direction wall includes at least one precast segment. In some example embodiments, at least one direction wall is coupled to one or more rock bolts and/or anchor bolts and/or any suitable means for securing the position of the direction wall.

The entrance region operational support system may comprise at least one attraction system 140. In some example embodiments, such as the one shown in FIG. 1A, the power generation system 100 comprises three attraction systems 140a, 140b, 140c. In alternative embodiments, the power generation system 100 may comprise a different number of attraction systems 140.

In the embodiment shown in FIG. 1A, each of the attraction systems 140 has a rectangular shape. In alternative embodiments, one or more of the attraction systems 140 may have a different shape.

In the embodiment shown in FIG. 1A, each of the attraction systems 140 is arranged in an elongated direction that is approximately orthogonal to the elongated direction of the waterway 5. In alternative embodiments, one or more of the attraction systems 140 may be arranged differently.

In some example embodiments, at least one of the at least one attraction system 140 may be configured to attract fish. In some example embodiments, at least one of the at least one attraction system 140 may be configured to attract aquatic creatures other than fish.

In some example embodiments, at least one of the at least one attraction system 140 comprises a gas infusion system. In some example embodiments, the gas infusion system may be configured to increase the amount of oxygen in the water around the attraction system 140. In some example embodiments, the gas infusion system may be configured to increase the amount of dissolved oxygen in the water around the attraction system 140.

In some example embodiments, the attraction system 140 may be configured to decrease the amount of nitrogen in the water around the attraction system 140. In some example embodiments, the attraction system 140 may be configured to decrease the amount of trace gases in the water around the attraction system 140.

In some example embodiments, the attraction system 140 may be configured to increase the amount of dissolved oxygen in the water around the attraction system 140 and decrease the amount of nitrogen and/or trace gases in the water around the attraction system 140. In some example embodiments, the attraction system 140 may be configured to increase the amount of dissolved oxygen in the water around the attraction system 140 at the same rate that it decreases the amount of nitrogen and/or trace gases in the water around the attraction system 140. In some example embodiments, the attraction system 140 may be configured to increase the amount of dissolved oxygen in the water around the attraction system 140 at about the same rate that it decreases the amount of nitrogen and/or trace gases in the water around the attraction system 140. In some example embodiments, the attraction system 140 may be configured to increase the amount of dissolved oxygen in the water around the attraction system 140 at about the same rate that it decreases the amount of nitrogen and/or trace gases in the water around the attraction system 140, such that the total gas pressure is not substantially changed.

In some example embodiments, the attraction system 140 comprises one or more control systems configured to control and/or provide power to the attraction system 140. In some example embodiments, one or more characteristics of the attraction system 140 may be adjusted. In some example embodiments, the attraction system 140 may be controlled on-site. In some example embodiments, the attraction system 140 may be controlled remotely.

In some example embodiments, the attraction system 140 is configured to be functionally coupled with the powerhouse 110. In some example embodiments, the attraction system 140 is configured to communicate with the powerhouse 110.

In some example embodiments, the attraction system 140 comprises at least one fish ladder. In some example embodiments, at least one of the at least one attraction system 140 is coupled to one or more rock bolts and/or anchor bolts and/or any suitable means for securing the position of the attraction system.

FIG. 1B is a perspective view of the power generation system of FIG. 1A. In some example embodiments, the powerhouse 110 comprises at least one access bridge 116. In the embodiment shown in FIG. 1B, the powerhouse 110 comprises one access bridge 116. Alternative embodiments may comprise a different number of access bridges.

In some example embodiments, the access bridge 116 may pass over one or more of the intake bays 112. In the embodiment shown in FIG. 1B, the access bridge 116 passes over all three intake bays 112. In some example embodiments, the access bridge 116 may pass over a portion of a direction wall 150. In some example embodiments, the access bridge 116 may allow access to one or more flood control gates 120.

In some example embodiments, a river-facing side of the entrance region support structure and a river-facing side of the powerhouse are composed of precast segments.

In some example embodiments, at an intersection between the powerhouse and the entrance region support structure, a precast segment from the powerhouse is adjacent to a precast segment of the entrance region support structure.

One or more navigation warning lights 152 may be mounted on one or more direction walls. In the embodiment shown in FIG. 1B, two navigation warning lights are mounted on a direction wall. In alternative embodiments a different number of navigation warning lights 152 may be mounted. In alternative embodiments one or more navigation warning lights 152 may be mounted at different locations. In some example embodiments, one or more of the navigation lights may be configured to adjust settings. In some example embodiments, one or more of the navigation lights may be configured to adjust settings in response to fluid volume conditions. For example, the navigation lights may be a certain color if the level of fluid volume is below a threshold. The navigation lights may be a different color if the level of fluid volume is at or above a threshold. Additionally, or alternatively, one or more navigation lights may change output intensity or may blink in response to different fluid volume conditions. In some example embodiments, characteristics of one or more navigation lights may communicate fluid volume information from one powerhouse to another powerhouse.

In some example embodiments, one or more of the navigation lights may be configured to adjust settings in response to aquatic life conditions. For example, the navigation lights may be a certain color if the level of detected aquatic life is below a threshold. The navigation lights may be a different color if the level of detected aquatic life is at or above a threshold. Additionally, or alternatively, one or more navigation lights may change output intensity or may blink in response to different aquatic life conditions. In some example embodiments, characteristics of one or more navigation lights may communicate aquatic life information from one powerhouse to another powerhouse.

In some example embodiments, fluid volume and/or aquatic life conditions near a powerhouse may be communicated using sound and/or sound alerts.

In some example embodiments, at least one of the at least one direction wall may be a different height than the other direction walls. In some example embodiments, at least one of the at least one entrance region direction walls may define at least one port from the entrance region 122 to the natural run-of-the-river passage portion 1 of the waterway 5. Such a port may allow aquatic life that enter the entrance region 122 to escape to the natural run-of-the-river passage portion 1 of the waterway 5. In some example embodiments, at least one of the at least one port in the direction wall may be at least partially covered by a gate. In some example embodiments, such a gate is configured to be electronically controlled. In some example embodiments, such a gate is configured to be electronically controlled in coordination with one or more elements of the entrance region operational support system. In some example embodiments, such a gate is configured to be manually controlled. In some example embodiments, a gate at at least one port in a direction wall may be configured to open or close under certain conditions. For example, the gate may be configured to open if the water level exceeds a certain level, or a certain amount of aquatic life is detected.

At least one direction wall may include one or more rotational sections constructed and arranged to rotate to allow water to flow out of the entrance region. The axis of rotation of this rotational section may be aligned along any direction, for example along a vertical axis, a horizontal axis, or any axis with vertical and horizontal components. For example, a rotational section may be at the top of a direction wall. If the fluid in the entrance region reaches the rotational section, the rotational section may rotate away from the entrance region and allow fluid or other material to exit the entrance region into the waterway. In some embodiments, a rotational section may be used in colder climates to enable ice to flow from the entrance region into the natural run-of-the river passage of the river. One or more of the rotational sections may be controlled using any suitable means, including, but not limited to, mechanical, electrical, pneumatic, or hydraulic means. In some example embodiments, one or more of the rotational sections may be controlled by a controller of the entrance region support system.

In some example embodiments, a direction wall may include one or more emergency gates constructed and arranged to translate open to allow water or ice to flow out of the entrance region into the waterway. The emergency gates may translate along any axis, including vertical, horizontal, or angles that include vertical and horizontal components. One or more of the emergency gates may be controlled using any suitable means, including, but not limited to, mechanical, electrical, pneumatic, or hydraulic means. In some example embodiments, one or more of the emergency gates may be controlled by a controller of the entrance region support system.

In some example embodiments, the power generation system may include one or more circulators constructed and arranged to circulate fluid. One or more of the circulators may be positioned in the entrance region to circulate water in the entrance region. In some example embodiments, one or more of the circulators may be controlled by a controller of the entrance region support system.

In some example embodiments, the power generation system may include one or more thermal heaters constructed and arranged to heat fluid. One or more of the thermal heaters may be positioned in the entrance region to heat water in the entrance region. In some example embodiments, one or more of the thermal heaters may be controlled by a controller of the entrance region support system.

In some example embodiments, the power generation system may include one or more heated gates positioned in front of an intake port of the powerhouse. One or more of the heated gates may be constructed and arranged to allow fluid to enter an intake port and prevent ice from entering an intake port. In some example embodiments, one or more of the heated gates may be controlled by a controller of the entrance region support system.

In some example embodiments, the power generation system may include one or more heated chambers positioned in front of an intake port of the powerhouse. One or more of the heated gates may be constructed and arranged to allow fluid to enter an intake port and prevent ice from entering the intake port. In some example embodiments, one or more of the heated chambers may be controlled by a controller of the entrance region support system.

In some example embodiments, the power generation system may include one or more heated intake tubes coupled to an intake port of the powerhouse. One or more of the heated intake tubes may be constructed and arranged to allow fluid to enter an intake port and prevent ice from entering the intake port or, if it does, from reaching a respective turbine. In some example embodiments, one or more of the heated intake tubes may be controlled by a controller of the entrance region support system.

In some example embodiments, an attraction system 140 may be coupled to at least one entrance region direction wall 150 to attract aquatic life to a port.

In FIG. 1B, a large red arrow indicates the direction 2 that fluid may take as it enters the powerhouse 110. Two large black arrows indicate the direction 4 of natural run-of-the-river passage though the waterway 5.

FIG. 1C is a perspective view of the power generation system of FIG. 1A. In FIG. 1C, a large red arrow indicates the direction 2 that fluid may take as it enters the powerhouse 110. A second large red arrow 3 indicates the direction that fluid may take as it exits the powerhouse 110. Two large black arrows indicate the direction 4 of passage though the waterway 5.

FIG. 1D shows an example embodiment of an adjustable intake arm 151 coupled to a direction wall 150a. In some example embodiments, the adjustable intake arm of a direction wall is used instead of the pivotable access control gate, and the adjustable intake arm has one or more characteristics described in connection with the pivotable access control gate.

An adjustable intake arm 151 may be included in the entrance region operational support system. An adjustable intake arm 151, such as the one shown in FIG. 1D may control access to an entrance region or an exit region associated with a powerhouse. In some embodiments, such as the one shown in FIG. 1D, the adjustable intake arm 151 comprises a coupling component 184. In some embodiments, the coupling component 184 is constructed and arranged to couple with a track 182. The track may define an opening 183. An upper portion 185 of the coupling component 184 may be coupled to the adjustable intake arm 151. A lower portion 186 of the coupling component 184 may be constructed and arranged such that it extends beyond the width of the opening 183, such that when the lower portion 186 of the coupling component 184 is inserted into the track 182 an end of the adjustable intake arm 151 can be opened or closed along the track 182 (see FIG. 1E).

In some embodiments, such as the one shown in FIG. 1D, the track 182 is constructed and arranged in a circular configuration such that the adjustable intake arm 151 rotates about an axis to open or close. In alternative embodiments, the track may be constructed and arranged differently.

In the embodiment shown in FIG. 1D, the adjustable intake arm 151 comprises one coupling component 184. In alternative embodiments, the adjustable intake arm 151 comprises more than one coupling component 182. In alternative embodiments, the adjustable intake arm 151 comprises more than one coupling component 182 constructed and arranged to mate with the same track. In alternative embodiments, the coupling component 184 may be arranged and/or positioned differently than the coupling component 184 shown in FIG. 1D. In some embodiments, at least one adjustable intake arm does not comprise a coupling component. In some embodiments, at least one adjustable intake arm operates independent from a track. In some embodiments, at least one adjustable intake arm comprises a locking mechanism so that the at least one adjustable intake arm may be secured at a position and/or orientation.

In some embodiments, the adjustable intake arm 151 may comprise a coupling component 184 near a lower surface (as shown in FIG. 1D) and a coupling component near an upper surface. In such embodiments, the lower coupling component 184 may be coupled to a lower track 182 (as shown in FIG. 1D) and the upper coupling component may be coupled to an upper track. Alternative embodiments may include a different coupling component that is constructed and arranged to couple with one or more tracks differently.

In some embodiments, the adjustable intake arm 151 is electronically controlled. In some embodiments, the adjustable intake arm 151 is coupled with one or more sensors and is configured to open or close in response to a sensed parameter.

FIG. 1E shows side view of an example embodiment of a coupling component 184 of an adjustable intake arm 151 and a track 182, in accordance with aspect of inventive features.

In some example embodiments, the adjustable intake arm of a direction wall is used instead of the pivotable access control gate, and the adjustable intake arm has one or more characteristics described in connection with the pivotable access control gate.

One or more of the components or elements described in connection with FIGS. 1A-1E may be coupled to a natural surface via a foundation. One or more of the components or elements described in connection with any other figure herein may be coupled to a natural surface via a concrete foundation. One or more of the components or elements described in connection with FIGS. 1A-1E may be directly coupled to a natural surface.

FIG. 2 is a top schematic view of an example embodiment of a power generation system 200 with a deterrence system 270 near the entrance region 222. In some example embodiments, such as the one shown in FIG. 2, entrance region operational support system comprises a deterrence system 270 that is located at or upstream of a perimeter of the entrance region 222. The deterrence system 270 may be configured to prevent fish or other aquatic life from entering the entrance region 222. In some example embodiments, the deterrence system 270 extends across an opening between two direction walls. In some example embodiments, the deterrence system 270 extends across part of an opening between two direction walls. In some example embodiments, the settings of the deterrence system 270 are adjustable. In some example embodiments, the deterrence system 270 may be selectively opened and closed. In some example embodiments, the deterrence system 270 extends across an opening between a direction wall and an adjustable intake arm. In some example embodiments, the deterrence system 270 extends across an opening between a direction wall and a natural surface.

In the embodiment shown in FIG. 2 a deterrence system 270 is shown near the entrance region 222. In some example embodiments, a deterrence system 270 may also be between two direction walls at the exit region 224. In some example embodiments, a deterrence system 270 may be between two direction walls at the entrance region 222 and/or the exit region 224. Some embodiments do not include a deterrence system. In some example embodiments, the deterrence system is located upstream of the entrance region. In some example embodiments, the deterrence system is located in the entrance region. In some example embodiments, the deterrence system is located adjacent to an intake port.

In some example embodiments, the deterrence system 270 comprises a barrier of bubbles. In some example embodiments, the arrangement of the bubbles is selectively configurable. In some example embodiments, the deterrence system 270 uses light to deter aquatic life. In some example embodiments, the deterrence system 270 uses acoustic waves to deter aquatic life. In some example embodiments, the deterrence system 270 uses electricity to deter aquatic life. In some example embodiments, the deterrence system 270 uses bacteria to deter aquatic life. In some example embodiments, the deterrence system 270 uses bioengineered mechanisms to deter aquatic life. In some example embodiments, the deterrence system 270 uses food to deter aquatic life. In some example embodiments, the deterrence system 270 uses any suitable natural or man-made mechanism to deter aquatic life. In some example embodiments, the deterrence system 270 uses carbon dioxide to deter aquatic life. In some example embodiments, the deterrence system 270 uses one or more approaches listed herein to deter aquatic life.

In FIG. 2, a large red arrow indicates the direction 2 that fluid may take as it enters the powerhouse 210. A second large red arrow indicates the direction 3 that fluid may take as it exits the powerhouse 210. Two large black arrows indicate the direction 4 of passage though the waterway 5.

The embodiment shown in FIG. 2 may include one or more of the elements and/or characteristics described in connection with the embodiments shown or described in connection with any other figure herein.

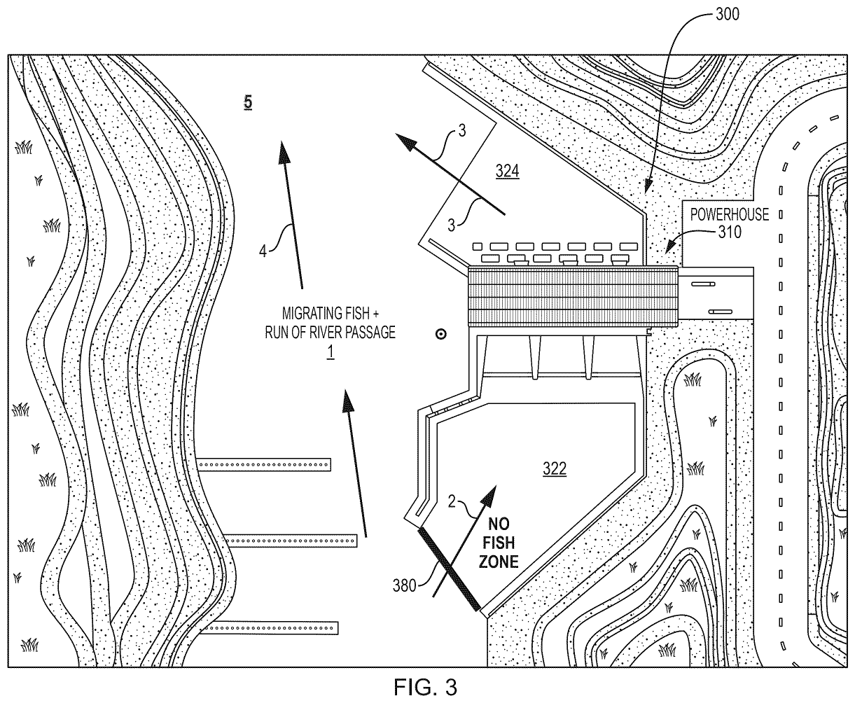

FIG. 3 is a top schematic view of an example embodiment of a power generation system 300 with an entrance region operational support system that includes an access control gate 380 near the entrance region 322. In some embodiments, such as the one shown in FIG. 3, the entrance region operational support system comprises an access control gate 380 that at least partially defines a perimeter of the entrance region 322.

The access control gate 380 may be configured to prevent fish or other aquatic life from entering the entrance region 322. In some example embodiments, the access control gate 380 extends across an opening between two direction walls. In some example embodiments, the access control gate 380 extends across part of an opening between two direction walls. In some example embodiments, the access control gate 380 may be selectively opened and closed.

In the embodiment shown in FIG. 3 an access control gate 380 is shown near the entrance region 322. In some example embodiments, an access control gate 380 may also be between two direction walls at the exit region 324. In some example embodiments, an access control 380 gate may be between two direction walls at the entrance region 322 and/or the exit region 324. Some embodiments do not include an access control gate.

The access control gate 380 may operate using hydraulics. The access control gate 380 may be slidingly coupled to a track such that it can be controllably moved to adjust access to the entrance region 322.

In FIG. 3, a large red arrow indicates the direction 2 that fluid may take as it enters the powerhouse 310. A second large red arrow indicates the direction 3 that fluid may take as it exits the powerhouse 310. Two large black arrows indicate the direction 4 of passage though the waterway 5.

The embodiment shown in FIG. 3 may include one or more of the elements and/or characteristics described in connection with the embodiments shown or described in connection with any other figure herein.

FIG. 4A shows an example embodiment of a pivotable access control gate 481 coupled to direction walls 450a, 450b. In some embodiments, a pivotable access control gate 481 replaces the adjustable intake arm of a direction wall. In some example embodiments, a pivotable access control gate 481 is in addition to the adjustable intake arm of a direction wall. In some example embodiments, the adjustable intake arm of a direction wall is used instead of the pivotable access control gate, and the adjustable intake arm has one or more characteristics described in connection with the pivotable access control gate.

A pivotable access control gate 481 may be included in the entrance region operational support system. A pivotable access control gate 481 such as the one shown in FIG. 4A may control access to an entrance region or an exit region associated with a powerhouse. In some embodiments, such as the one shown in FIG. 4A, the access control gate 481 comprises a coupling component 484. In some embodiments, the coupling component 484 is constructed and arranged to couple with a track 482. The track may define an opening 483. An upper portion 485 of the coupling component 484 may be coupled to the pivotable access control gate 481. A lower portion 486 of the coupling component 484 may be constructed and arranged such that it extends beyond the width of the opening 483, such that when the lower portion 486 of the coupling component 484 is inserted into the track 482 an end of the pivotable access control gate 481 can be opened or closed along the track 482 (see FIG. 4B).

In some embodiments, such as the one shown in FIG. 4A, the track 482 is constructed and arranged in a circular configuration such that the pivotable access control gate 481 rotates about an axis to open or close. In alternative embodiments, the track may be constructed and arranged differently.

In the embodiment shown in FIG. 4A, the pivotable access control gate 481 comprises one coupling component 484. In alternative embodiments, the pivotable access control gate 481 comprises more than one coupling component 482. In alternative embodiments, the pivotable access control gate 481 comprises more than one coupling component 482 constructed and arranged to mate with the same track. In alternative embodiments, the coupling component 484 may be arranged and/or positioned differently than the coupling component 484 shown in FIG. 4A. In some embodiments, at least one pivotable access control gate does not comprise a coupling component. In some embodiments, at least one pivotable access control gate operates independent from a track. In some embodiments, at least one pivotable access control gate comprises a locking mechanism so that the at least one access control gate may be secured at a position and/or orientation.

In some embodiments, the pivotable access control gate 481 may comprise a coupling component 484 near a lower surface (as shown in FIG. 4A) and a coupling component near an upper surface. In such embodiments, the lower coupling component 484 may be coupled to a lower track 482 (as shown in FIG. 4A) and the upper coupling component may be coupled to an upper track. Alternative embodiments may include a different coupling component that is constructed and arranged to couple with one or more tracks differently.

In some embodiments, the pivotable access control gate 481 is electronically controlled. In some embodiments, the pivotable access control gate 481 is coupled with one or more sensors and is configured to open or close in response to a sensed parameter.

FIG. 4B shows side view of an example embodiment of a coupling component 484 of a pivotable access control gate 481 and a track 482.

The embodiment shown in FIG. 4 may include one or more of the elements and/or characteristics described in connection with the embodiments shown or described in connection with any other figure herein.

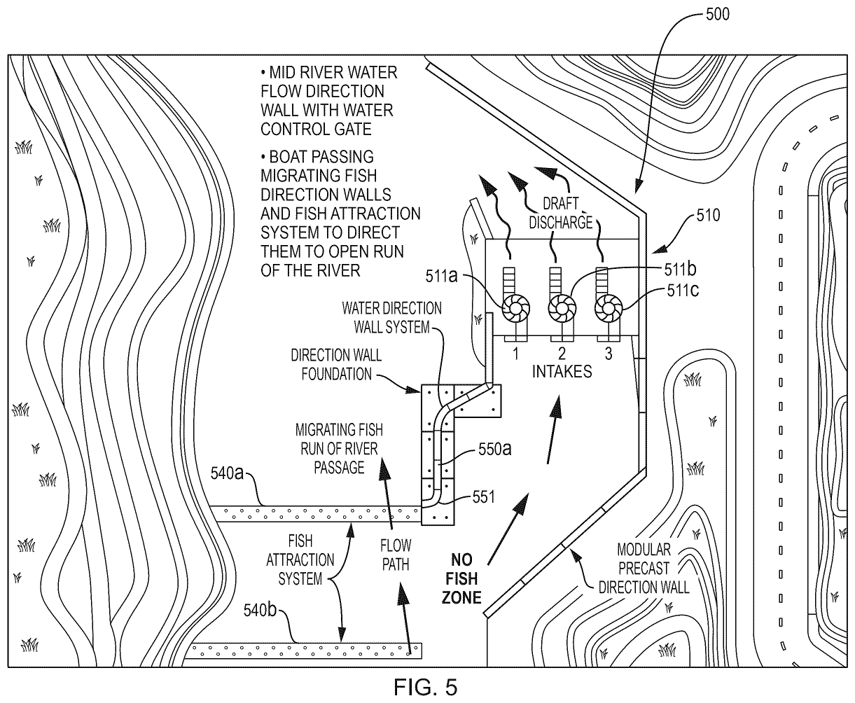

FIG. 5 is a top schematic view of an example embodiment of a power generation system 500. In some embodiments, at least one attraction system 540 may extend to (or nearly to) a direction wall 550. In this embodiment, the direction wall 550 includes an adjustable region 551. In such embodiments, the natural run-of-the-river portion 1 of the waterway 5 extends over the attraction system 140. In the embodiment shown in FIG. 5, the powerhouse 510 comprises three power generation mechanisms 511a, 511b, 511c. In alternative embodiments, the powerhouse 510 may comprise a different number of power generation mechanisms.

The embodiment shown in FIG. 5 may include one or more of the elements and/or characteristics described in connection with the embodiments shown or described in connection with any other figure herein.

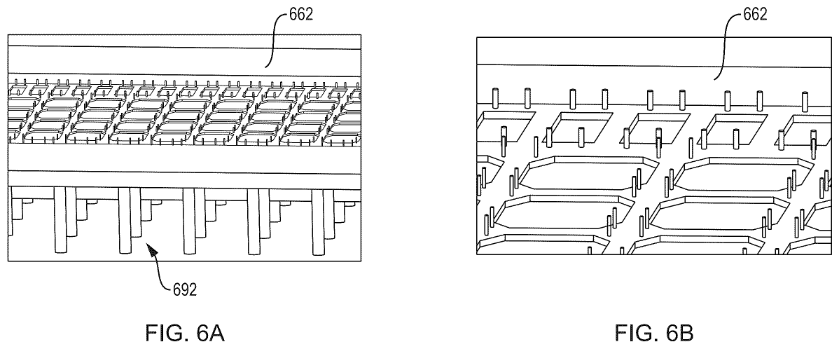

FIG. 6A shows a perspective of an example embodiment of a working platform 662 coupled to rock bolts 692.

FIG. 6B shows a close-up view of the working platform 662 of FIG. 6A. In some example embodiments, such we the one shown in FIG. 6B, the working platform 662 comprises pleats and/or grooves configured to couple with segments of a dam/or powerhouse. In alternative embodiments the cutoff wall may not comprise grooves.

In some embodiments, such we the one shown in FIG. 6B, the working platform 662 is coupled to connectors to couple with segments of a dam. In alternative embodiments, the working platform may not be coupled to connectors.

The embodiment shown in FIG. 6 may include one or more of the elements and/or characteristics described in connection with the embodiments shown or described in connection with any other figure herein.

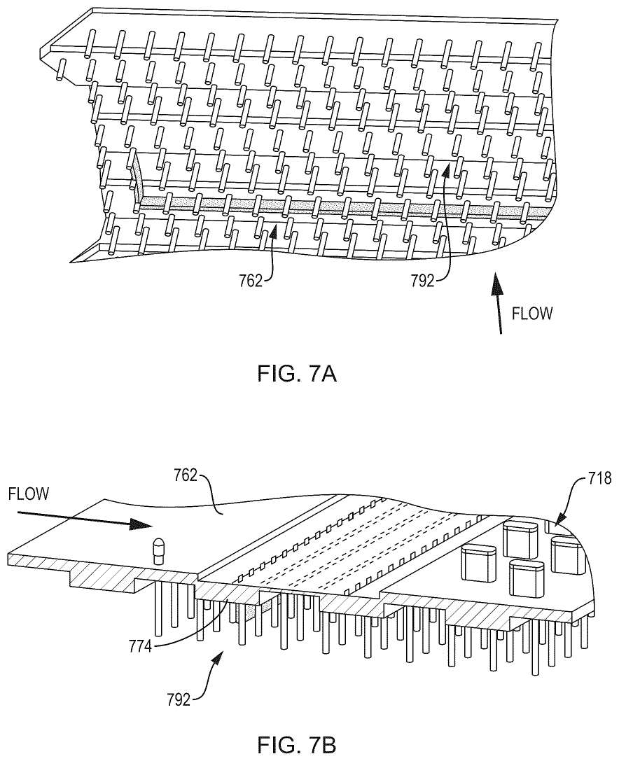

FIG. 7A shows a perspective view of an example embodiment of a working platform 762 coupled to multiple rock bolts 792.

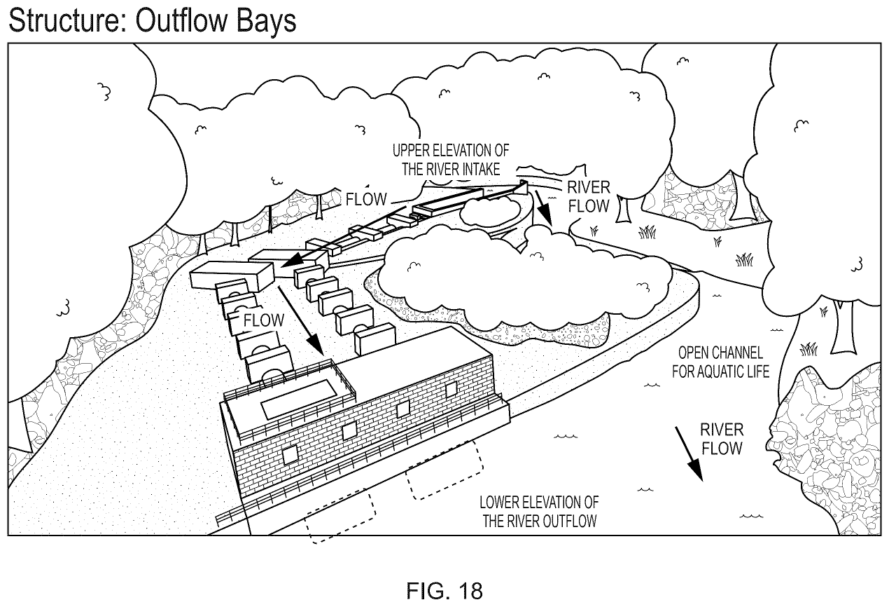

FIG. 7B shows a perspective view of a working platform coupled to multiple cleats 774, rock bolts 792, and diffusers 718. In the example embodiment shown in FIG. 18B, the diffusers being coupled to a downstream side of the working platform. In alternative embodiments, the working platform may be coupled to diffusers at the upstream side of the working platform. In alternative embodiments, the working platform may not be coupled to cleats. In alternative embodiments, the working platform may not be coupled to rock bolts. In alternative embodiments, the working platform may not be coupled to diffusers.

The embodiment shown in FIG. 7 may include one or more of the elements and/or characteristics described in connection with the embodiments shown or described in connection with any other figure herein.

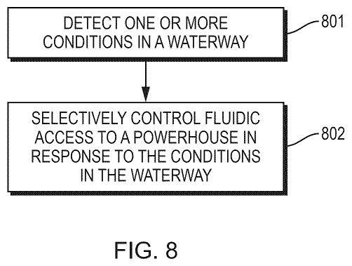

FIG. 8 shows an embodiment of a method of operating a power generation system. In some example embodiments the entrance region operational support system includes a controller that coordinates the activity of one or more elements of the entrance region operational support system in response to conditions in a waterway. The entrance region operational support system may detect one or more conditions in a waterway 801; and selectively control fluid access or aquatic life access to a powerhouse in response to the conditions in the waterway 802. The method may further comprise detecting the presence of aquatic life and adjusting the settings of at least one of the at least one attraction system based, at least in part, on the detected presence of aquatic life. The method may further comprise selectively controlling fluid access to a powerhouse using a gate. The method may further comprise selectively controlling fluid access to a powerhouse using a deterrence system. The method may include activating one or more alarms in response to specified changes in the level of fluid and/or aquatic life. The method may include coordinating one or more elements of the entrance region operational support system to control fluid volume and/or aquatic life in the entrance region.

The embodiment shown in FIG. 8 may include one or more of the elements and/or characteristics described in connection with the embodiments shown or described in connection with any other figure herein.

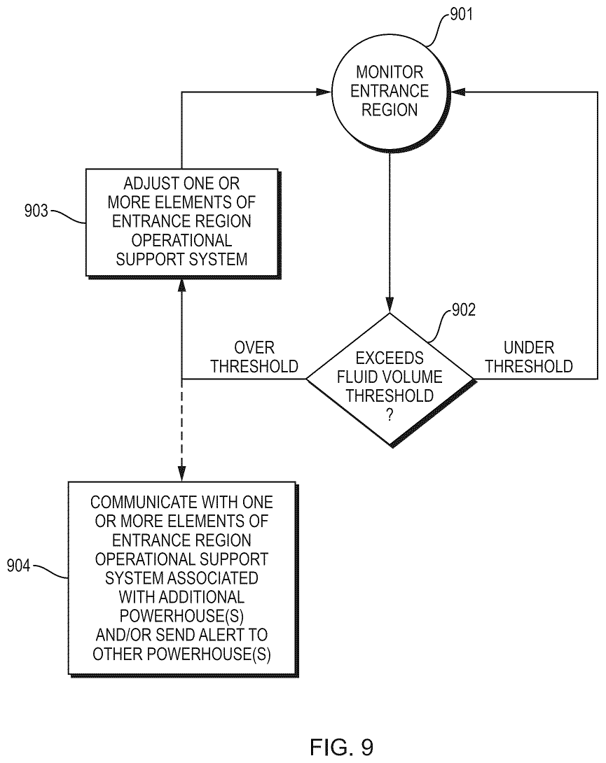

FIG. 9 shows an example method of operating a power generation system. In some embodiments, the entrance region is monitored 901 to determine if the level of fluid volume exceeds a threshold 902.

If the level of fluid volume is under the threshold, the monitoring of the entrance region continues. If the level of fluid volume is at or above the threshold one or more elements of the entrance region operation support system are adjusted 903. After the adjustment, the entrance region is monitored.

In some example embodiments, the entrance region operational support system coordinates activity among multiple powerhouses and various additional elements. If the method indicates that one or more elements associated with a particular powerhouse (e.g., gates, attraction system) should be adjusted in response to fluid volume, information can be communicated to elements associated with one or more of the additional powerhouses 904.

The embodiment shown in FIG. 9 may include one or more of the elements and/or characteristics described in connection with the embodiments shown or described in connection with any other figure herein.

In some example embodiments, the level of fluid volume and/or the level of aquatic life may be measured at different powerhouses. For example, the level of fluid volume may be measured near a first powerhouse and that information may be communicated to elements of the entrance region operational support system near a second powerhouse. The level of aquatic life may be measured at the second powerhouse and communicated to elements of the entrance region operational support system near the first powerhouse.

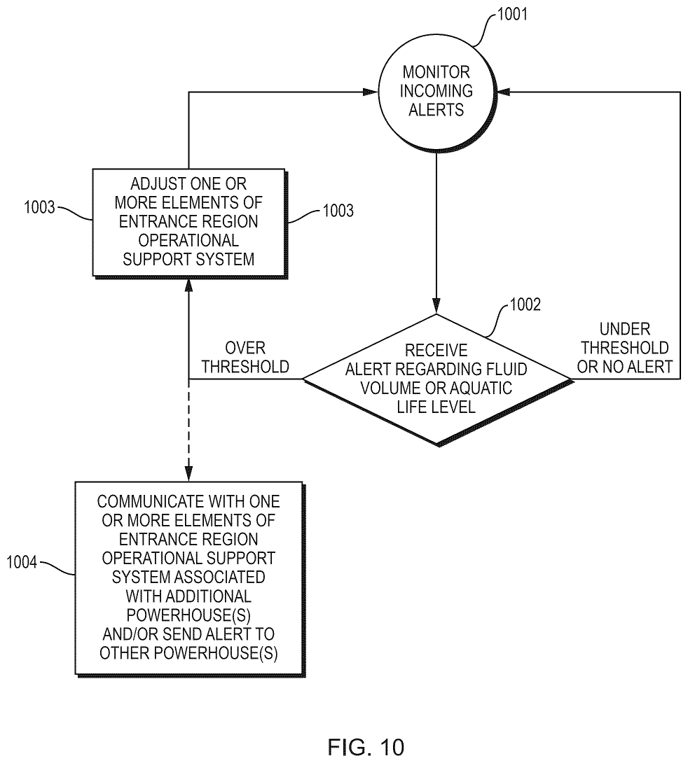

FIG. 10 shows an example method of operating a power generation system. In some embodiments, the system monitors for incoming alerts 1001. If the system receives an alter regarding fluid volume or level of aquatic life, the system determines if the level of fluid volume and/or level of aquatic life exceeds a threshold 1002.

If the level of fluid volume and/or level of aquatic life is under the threshold (or no alert is received), the monitoring continues. If the level of fluid volume and/or level of aquatic life is at or above the threshold one or more elements of the entrance region operation support system are adjusted 1003. After the adjustment, the monitoring continues.

In some example embodiments, the entrance region operational support system coordinates activity among multiple powerhouses and various additional elements. If the method indicates that one or more elements associated with a particular powerhouse (e.g., gates, attraction system) should be adjusted in response to fluid volume, information can be communicated to elements associated with one or more of the additional powerhouses 1004.

The embodiment shown in FIG. 10 may include one or more of the elements and/or characteristics described in connection with the embodiments shown or described in connection with any other figure herein.

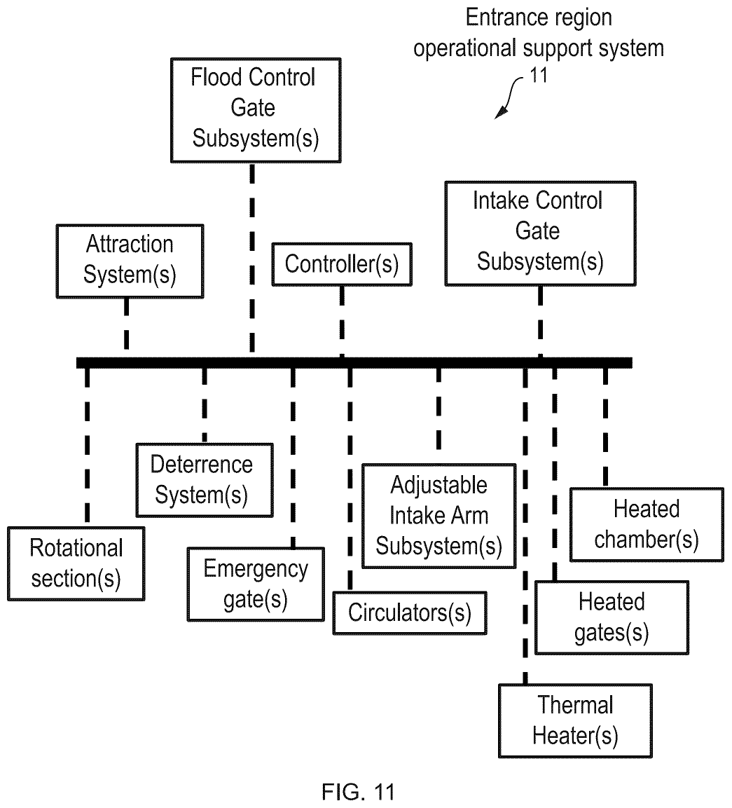

FIG. 11 shows an example embodiment of an entrance region operational support system. In some example embodiments, the entrance region operations support system includes fewer than all of the elements shown in FIG. 11. In some example embodiments, the entrance region operations support system includes additional elements not shown in FIG. 11. In some example embodiments, the elements shown are associated with different powerhouses. For example, a first attraction system may be associated with a first powerhouse and a second attraction system may be associated with a second powerhouse. For example, one powerhouse may be associated with an attraction system and another powerhouse may be associated with a deterrence system.

In the embodiment shown in FIG. 11, the elements are in communication with each other. In some example embodiments, a subset of all the elements of the entrance region operations support system are in communication with each other. For example, the elements of a first powerhouse and a second powerhouses may be in communication and, independently, the elements of a third powerhouse and a fourth powerhouse may be in communication. Alternatively, one or more of each type of element may be in independent communication. For example, one or more of the attraction systems may be in communication and, independently, one or more of the gates may be in communication.

In some example embodiments, sensors may detect the presence of aquatic life and adjust settings of at least one of the at least one attraction system based, at least in part, on the presence of aquatic life detected. An increase in aquatic life could be detected near a first powerhouse, and that information could be communicated to an attraction system near a second powerhouse. Such information could be used to adjust the settings of an attraction system to attract more aquatic life. Similar coordination could be used to adjust the settings of each of the elements described herein in connection with the entrance region operational support system 11.

The embodiment shown in FIG. 11 may include one or more of the elements and/or characteristics described in connection with the embodiments shown or described in connection with any other figure herein.

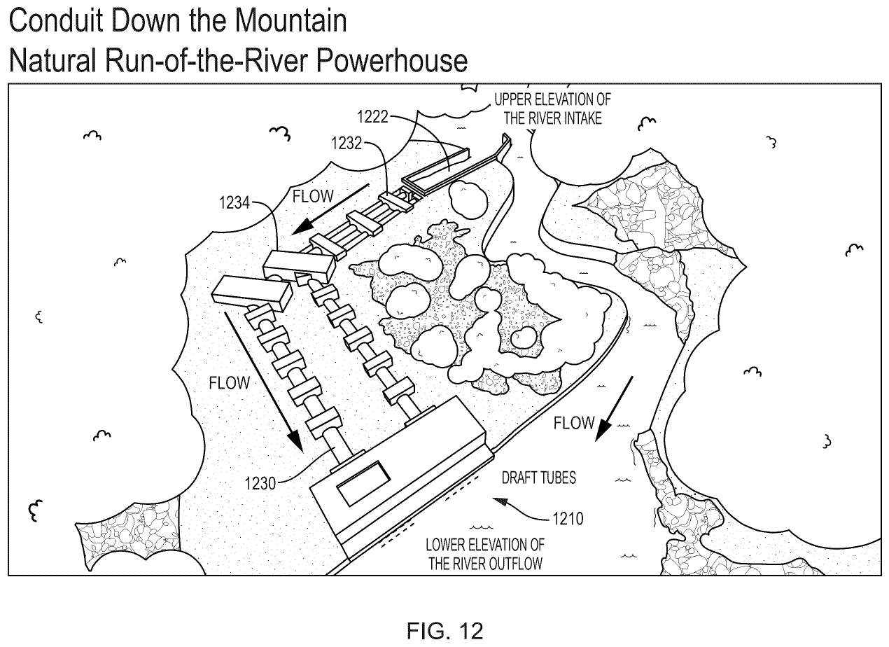

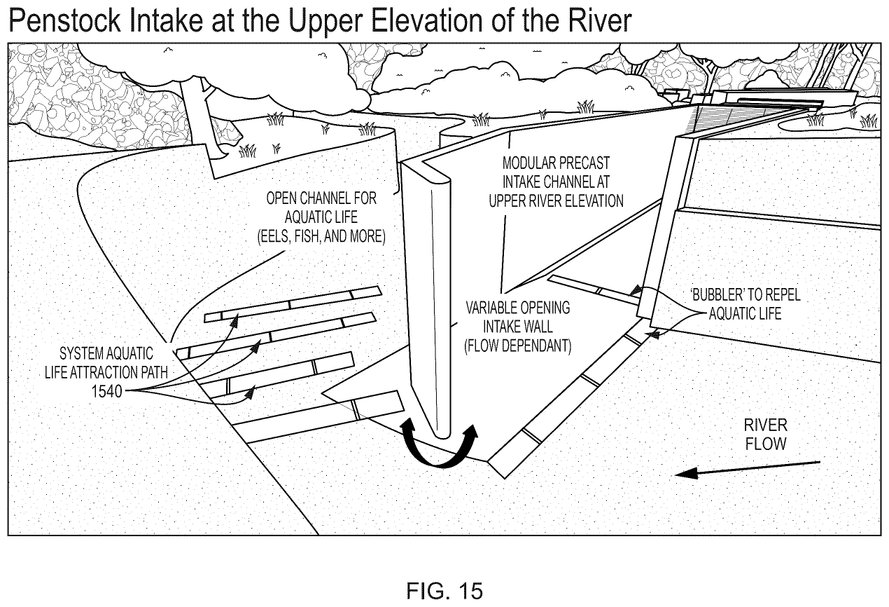

FIGS. 12-36 show example embodiments of a power generation system. The variable opening intake wall (for example see FIG. 15) and/or variable intake wall may have one or more characteristics in common with the adjustable intake arm. The ‘bubbler’ may be included in a deterrence system. The flow diverter may have one or more characteristics in common with the diffusers.

FIG. 12 shows an example embodiment of a power generation system in which the entrance region 1222 is coupled to the powerhouse 1210 using fluid conduits 1230. In some embodiments, such as the one shown in FIG. 12, the fluid conduits are positioned over land. In alternative embodiments, the fluid conduits may be at least partially in a fluid, such as water.

In some embodiments, such as the one shown in FIG. 12, two fluid conduits fluidically couple the entrance region to the powerhouse. In alternative embodiments, a different number of fluid conduits may be used.

In some embodiments, such as the one shown in FIG. 12, one or more thrust blocks 1232 may be used to secure the position of a fluid conduit. In alternative embodiments, a different number of thrust blocks may be used.

In some embodiments, such as the one shown in FIG. 12, one or more corner thrust blocks 1234 may be used to secure the position of a fluid conduit. In alternative embodiments, a different number of corner thrust blocks may be used.

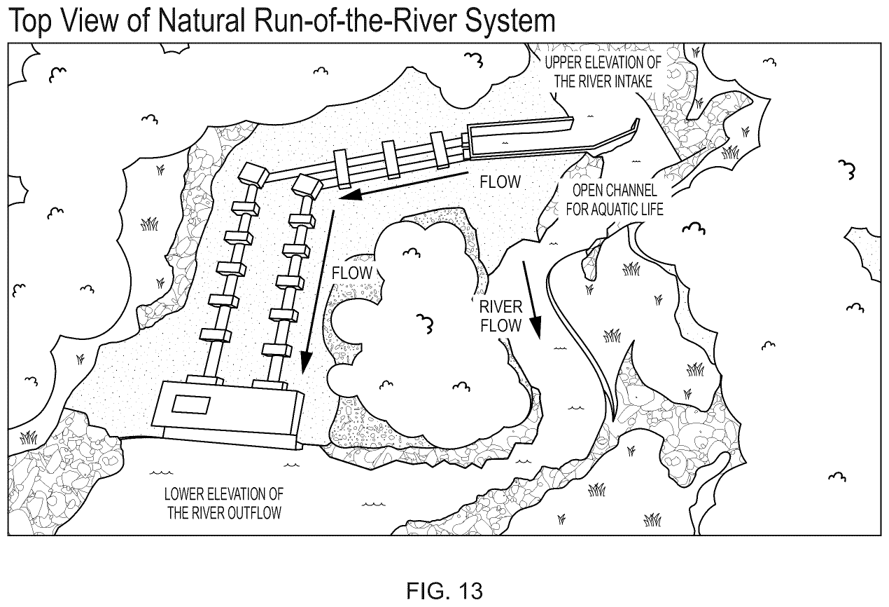

FIG. 13 shows a top view an example embodiment of a power generation system in which the entrance region is coupled to the powerhouse using fluid conduits.

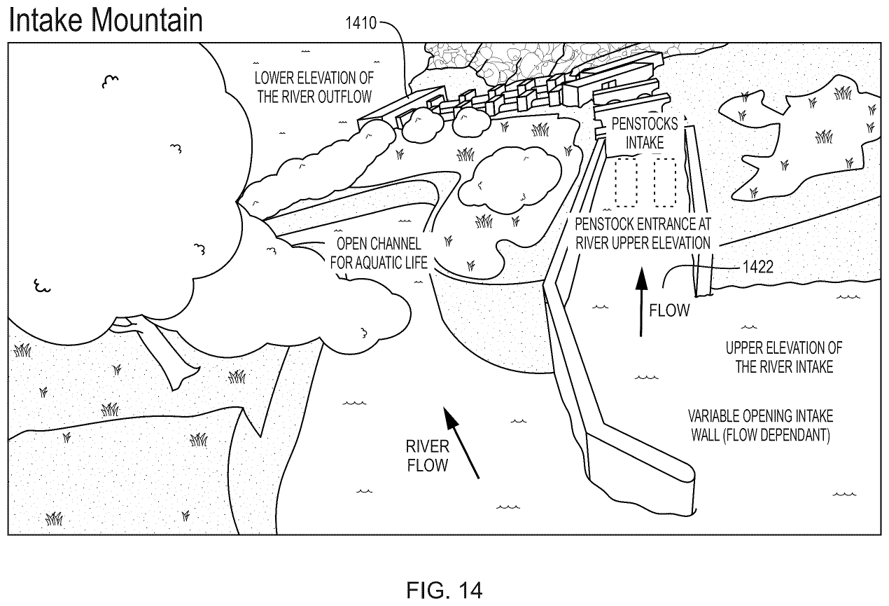

FIG. 14 shows an example embodiment of an entrance region 1422 of a power generation system. In this embodiment, the power generation system includes a variable opening intake wall 1451, which may have one or more characteristics in common with the adjustable intake arm.

FIG. 15 shows an example embodiment of a power generation system and an attraction system 1540.

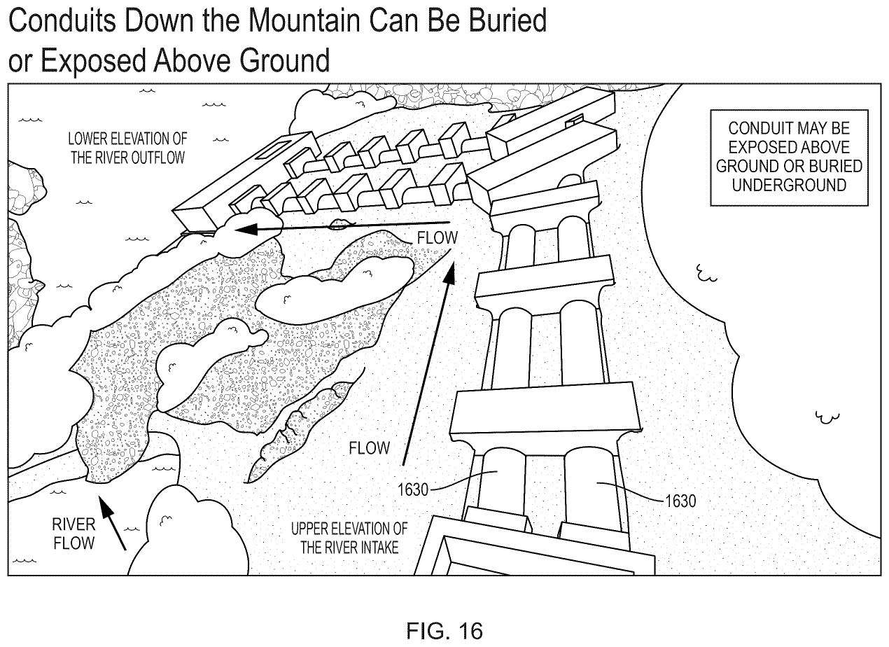

FIG. 16 shows an example embodiment of a power generation system with two fluid conduits 1630a, 1630b. In alternative embodiments, the power generation system may include a different number of fluid conduits. One or more of the fluid conduits may be buried below ground, above ground, or partially buried below ground.

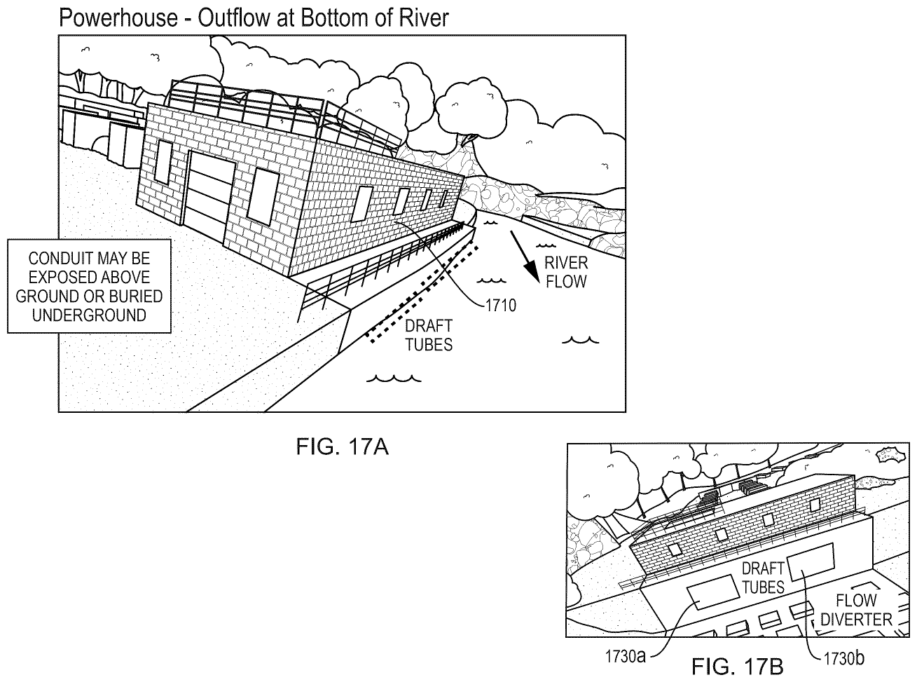

FIG. 17A shows an example embodiment of a powerhouse 1710 of a power generation system.

FIG. 17B shows an example embodiment of a powerhouse and two draft ports 1730a, 1730b.

FIG. 18 shows an example embodiment of a power generation system.

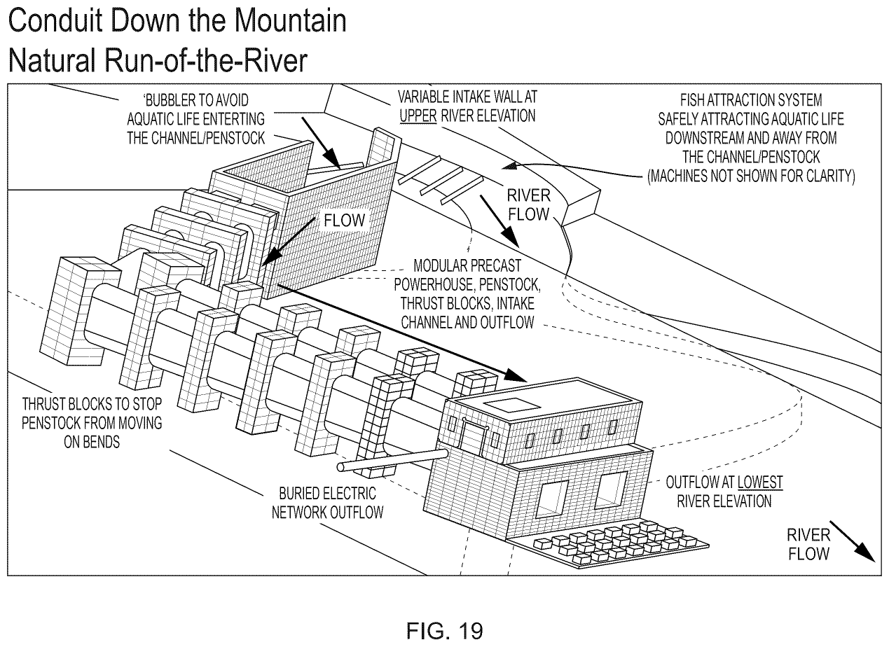

FIG. 19 shows an example embodiment of a power generation system.

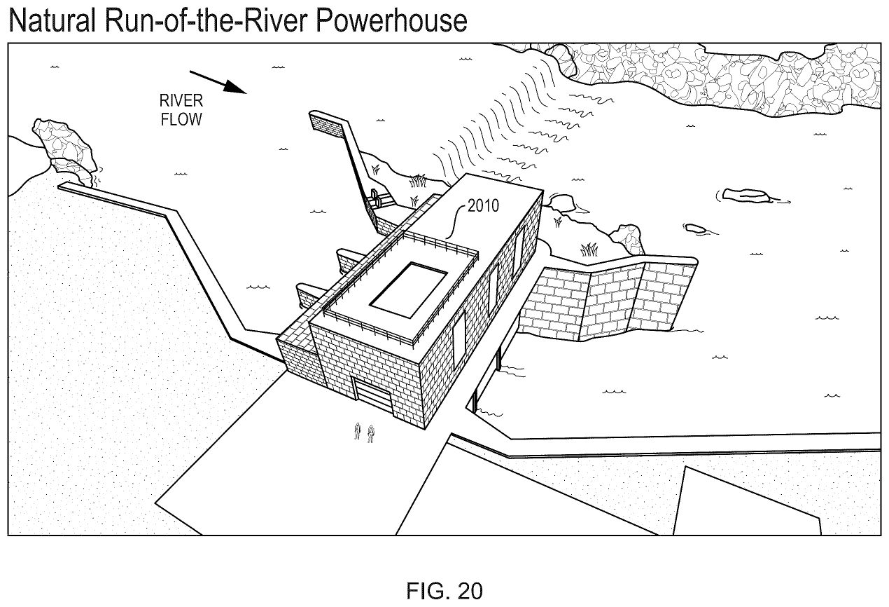

FIG. 20 shows an example embodiment of a powerhouse 2010 of a power generation system.

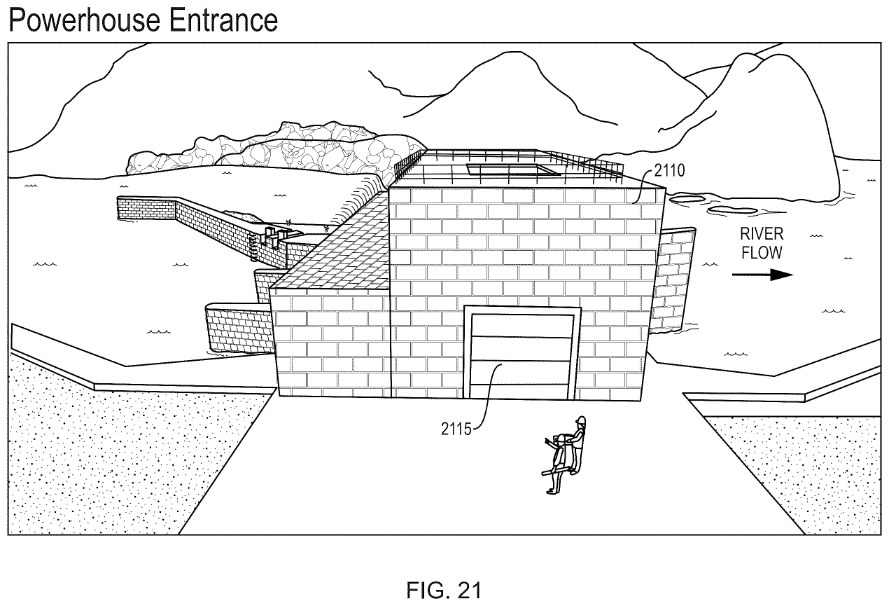

FIG. 21 shows an example embodiment of an entrance 2115 to a powerhouse 2110 of a power generation system.

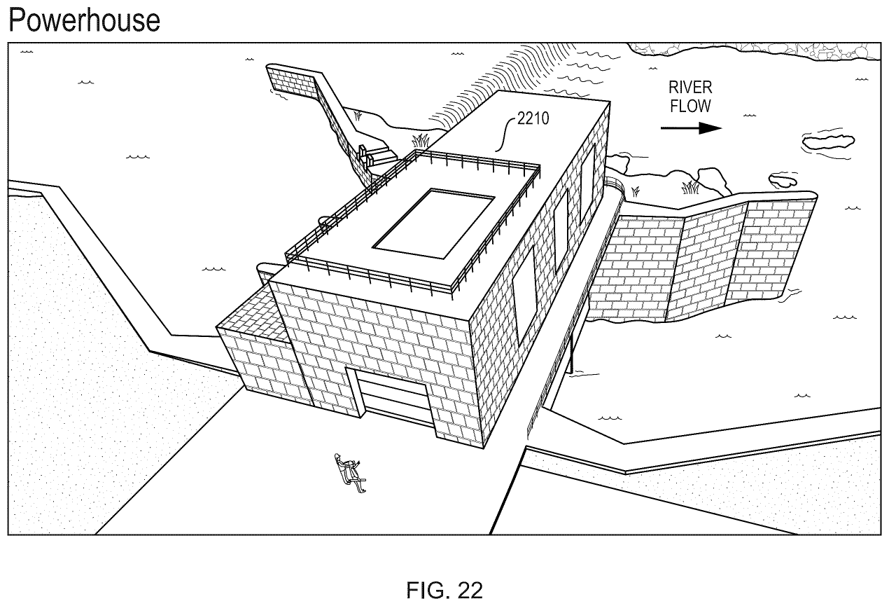

FIG. 22 shows an example embodiment of a powerhouse 2210 of a power generation system.

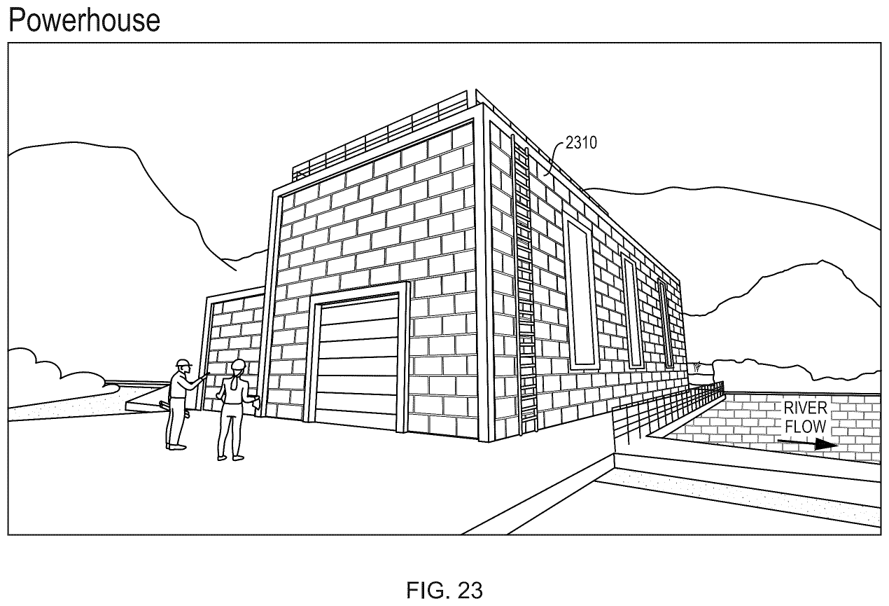

FIG. 23 shows an example embodiment of a powerhouse 2310 of a power generation system. A ladder is shown facilitating access to a roof of the powerhouse.

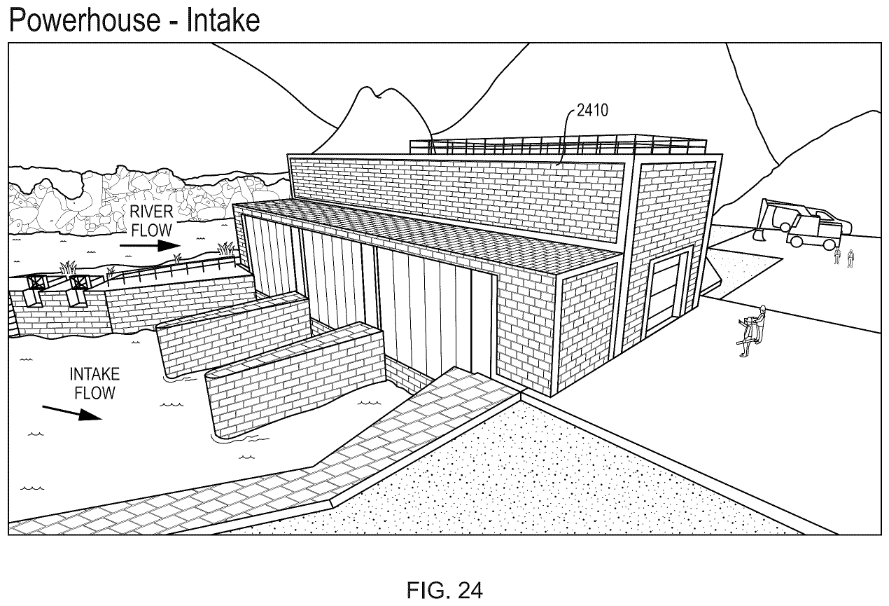

FIG. 24 shows an example embodiment of a powerhouse 2410 of a power generation system.

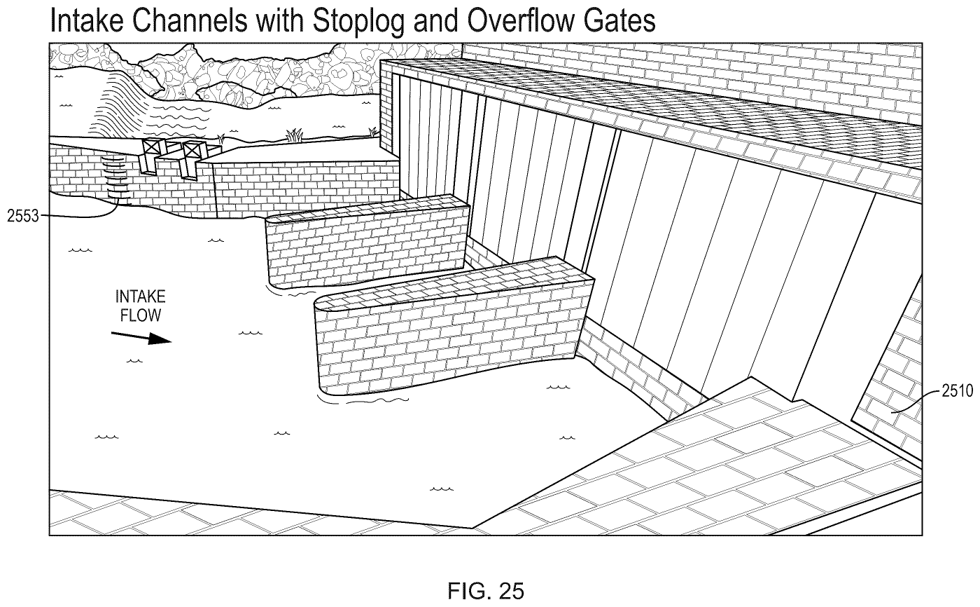

FIG. 25 shows an example embodiment of a powerhouse 2510 of a power generation system. In the embodiment shown in FIG. 25 a ladder 2553 is constructed and arranged to allow for access into and out of the entrance region.

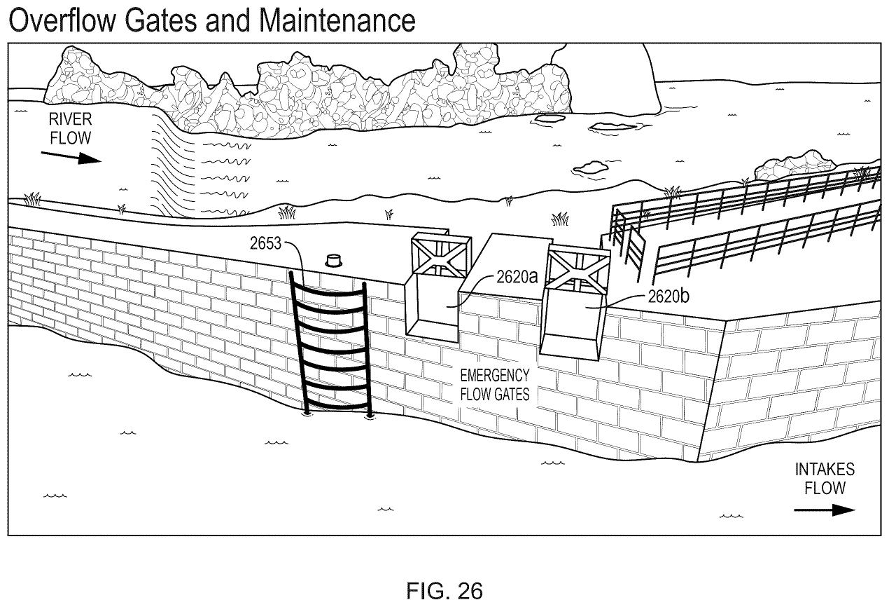

FIG. 26 shows an example embodiment of a ladder 2653 and flood control gates 2620a, 2620b (also referred to as overflow gates). In alternative embodiments, the power generation system may include a different number of flood control gates.

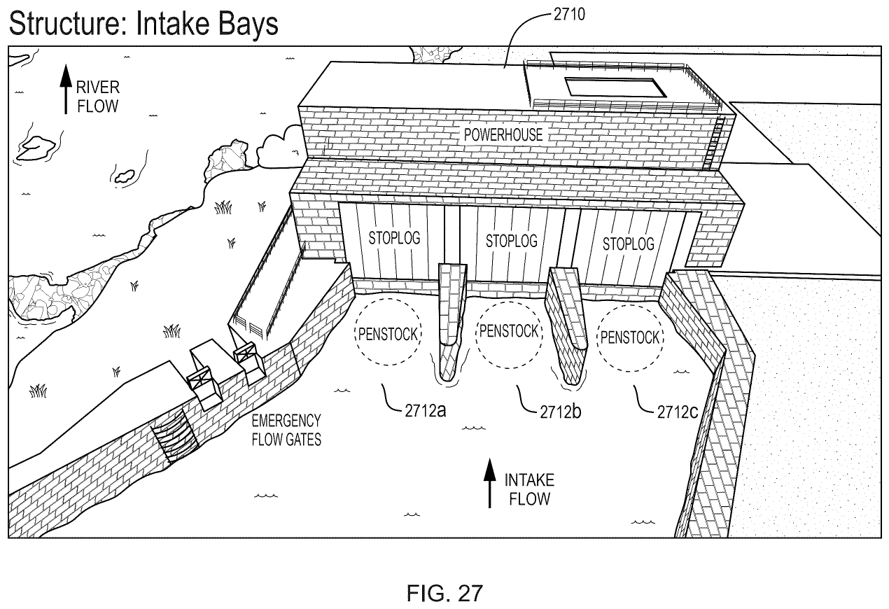

FIG. 27 shows an example embodiment of a powerhouse 2710 with three intake bays 2712a, 2712b, 2712c. In the embodiment shown, each intake bay is coupled to an input port. In the embodiment shown, each intake port is blocked with a stoplog.

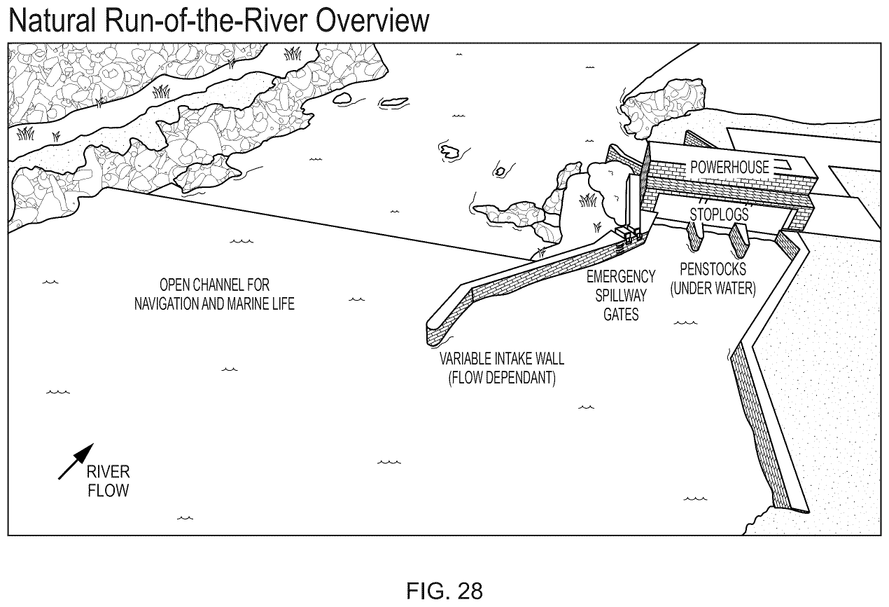

FIG. 28 shows an overview of an example embodiment of a power generation system.

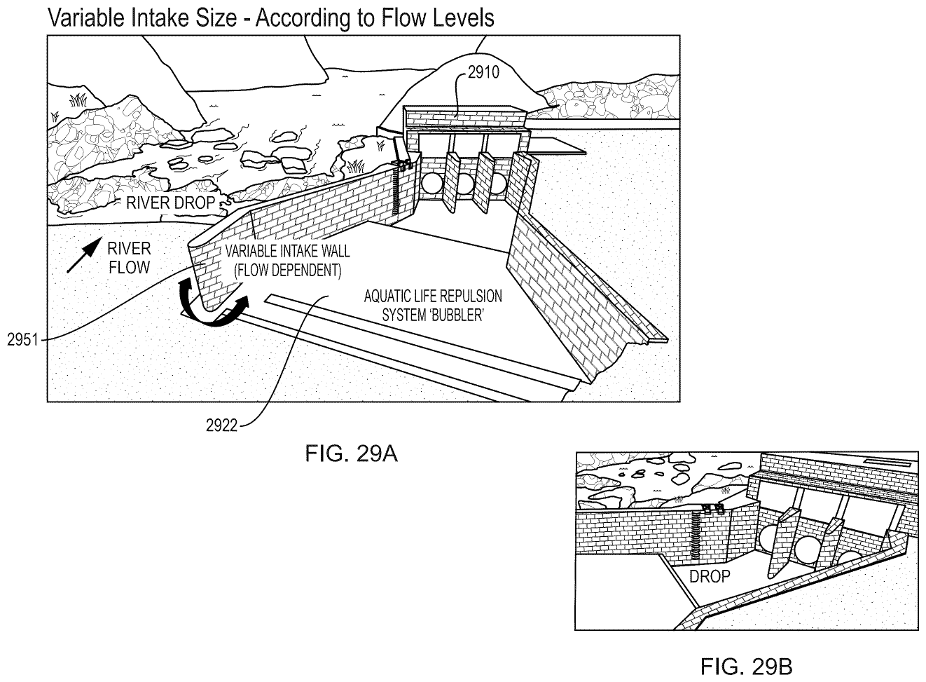

FIG. 29A shows an example embodiment of a powerhouse, an entrance region, and a variable intake arm, without fluid in the entrance region.

FIG. 29B shows an example embodiment of a powerhouse and an entrance region.

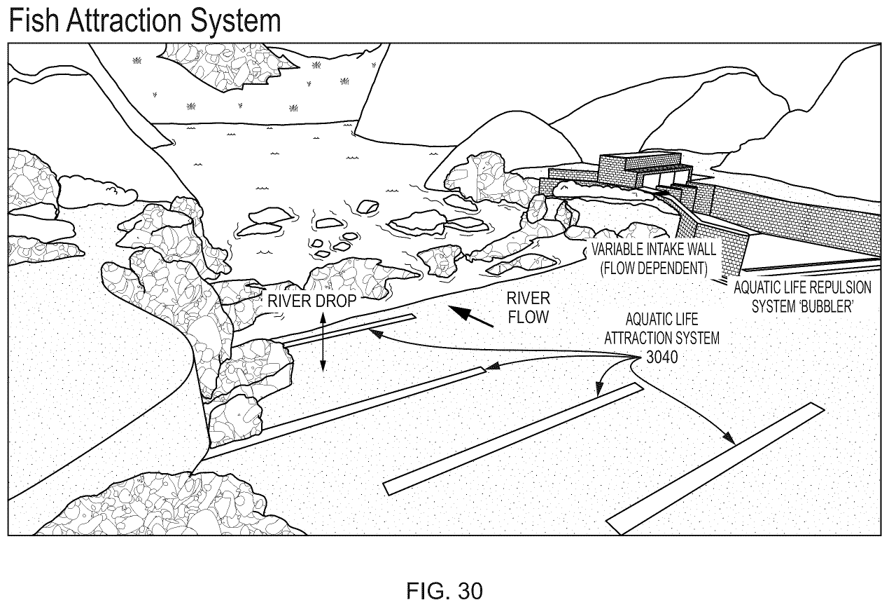

FIG. 30 shows an example embodiment of a power generation system that includes an attraction system 3040, without fluid covering the attraction system.

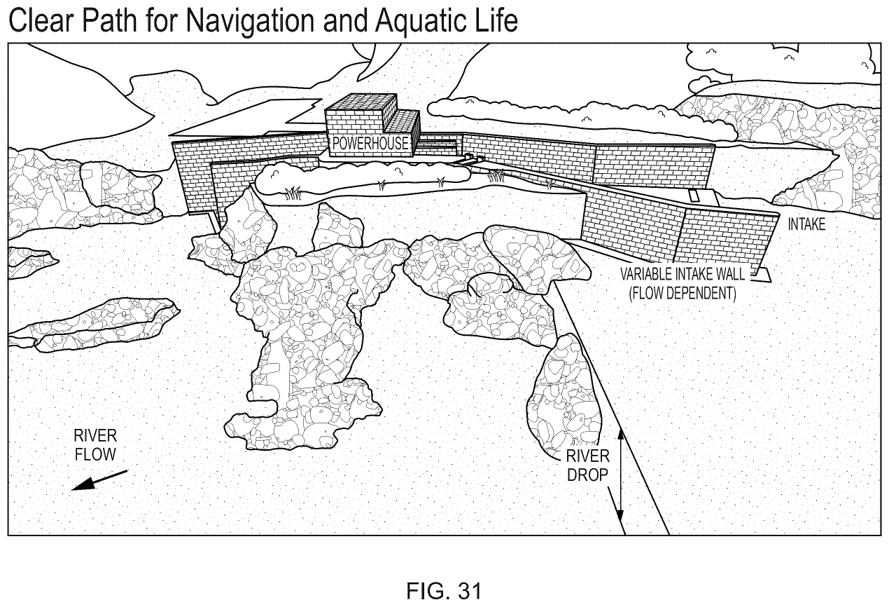

FIG. 31 shows an example embodiment of a power generation system, without fluid adjacent to the powerhouse.

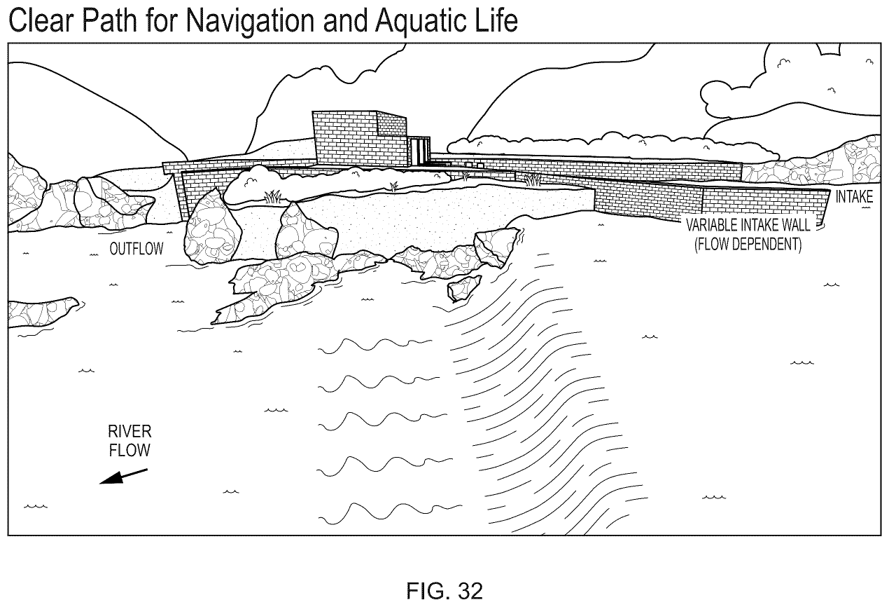

FIG. 32 shows an example embodiment of a power generation system, with fluid adjacent to the powerhouse.

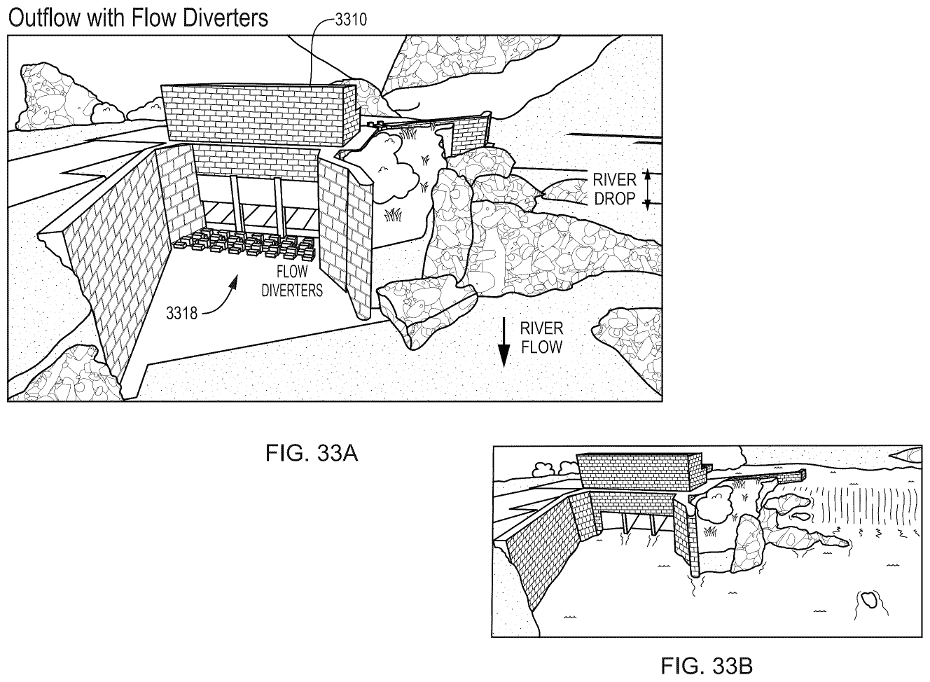

FIG. 33A shows an example embodiment of an output region of a powerhouse 3310 and diverters 3318 (also referred to as diffusers), without fluid in the output region.

FIG. 33B shows an example embodiment of an output region of a powerhouse with fluid adjacent to the powerhouse.

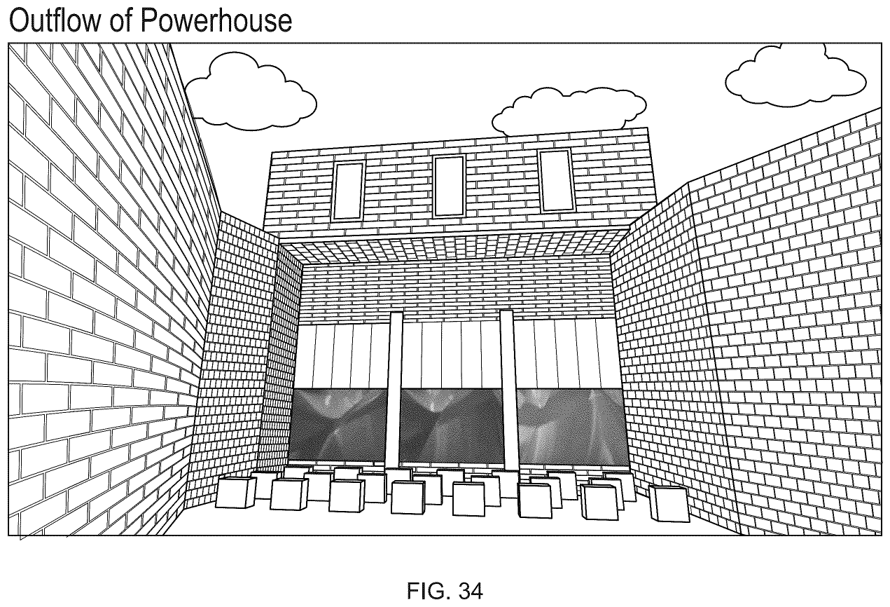

FIG. 34 shows an example embodiment of an output region of a powerhouse with diverters, without fluid in the output region.

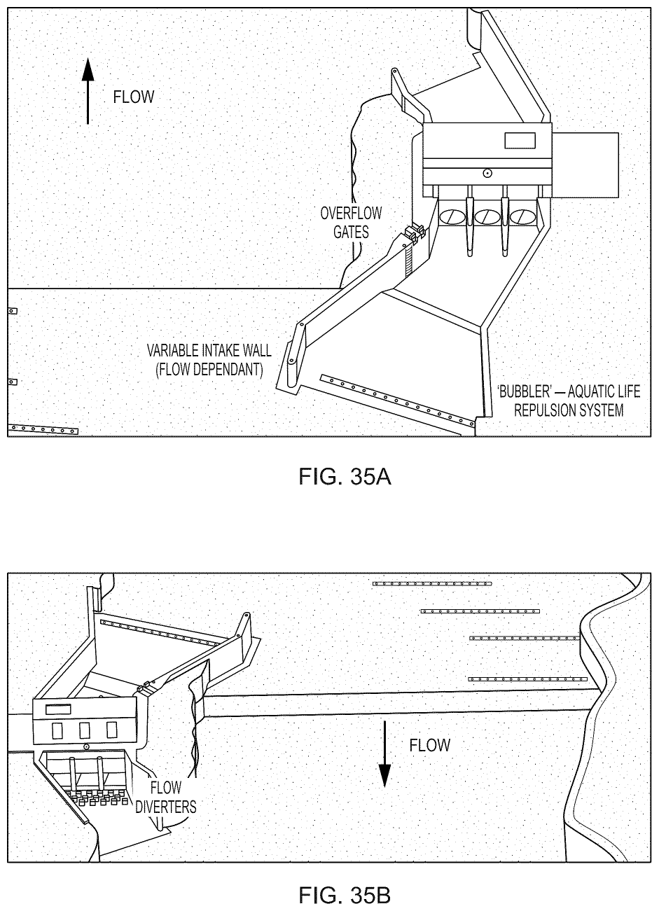

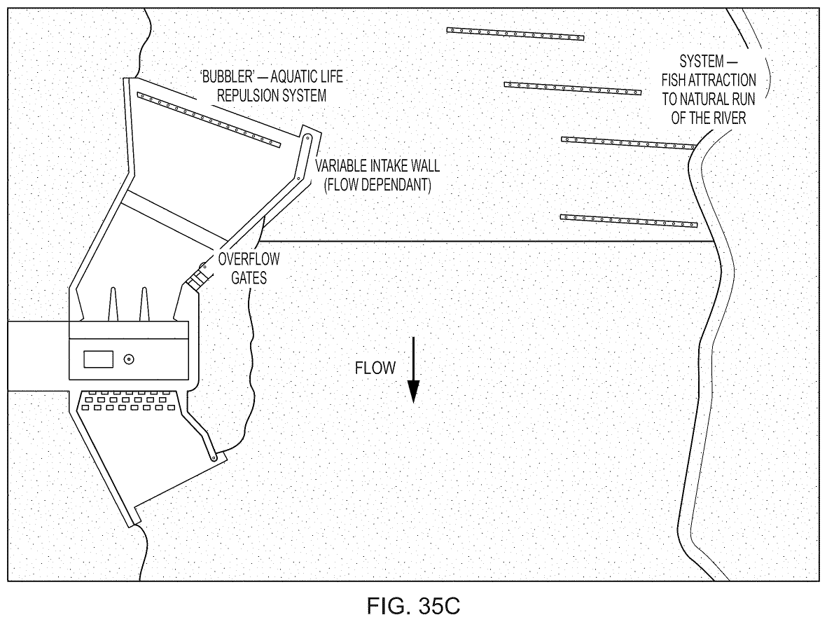

FIG. 35A shows an example embodiment of a power generation system from the intake side of the powerhouse.

FIG. 35B shows an example embodiment of a power generation system from the output side of the powerhouse.

FIG. 35C shows a top view of an example embodiment of a power generation system.

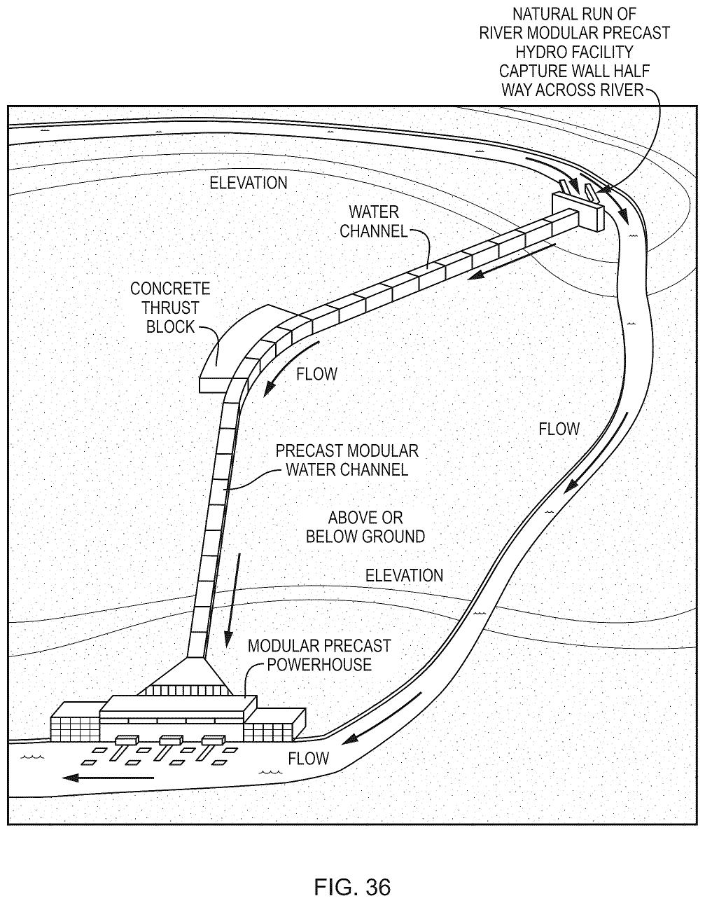

FIG. 36 shows an example embodiment of a power generation system.

In some embodiments, the power generation system may include one or more precast floating modules configured to float in a fluid. In some embodiments, the one or more precast floating modules are configured to reduce fluid flow. In some embodiments, the one or more precast floating modules are configured to reduce ice jams. In some embodiments one or more of the one or more precast floating modules are coupled to a natural surface, for example a riverbed.

In some example embodiments, at least some of precast segments described herein are produced using a 3D printing process.

In various embodiments, one or more of the precast segments may be coupled using at least one dowel, at least one bolt, at least one keyway, at least one re-rod, or at least one port. In various embodiments, one or more of the modular blocks may be coupled using at least one expandable linkage, at least one automatic linkage (that locks itself), at least one prestressed cable (vertical configuration, horizontal configuration, or other configuration), at least one linkage port, or any other mechanism suitable for connecting items.

In various example embodiments, spaces between neighboring precast segments may be filled with concrete, grout, liners, or water stopping agents. In various example embodiments, spaces between precast segments and other elements (for example, fluid conduits) may be filled with concrete, grout, liners, or water stopping agents. In various example embodiments, spaces within precast forms may be filled with concrete, grout, liners, or water stopping agents. In various example embodiments, spaces between any elements associated with a powerhouse or dam may be filled with concrete, grout, liners, or water stopping agents.

In various example embodiments, one or more nanotech coatings may be applied to seals or filler materials between neighboring precast segments. In various example embodiments, one or more nanotech coatings may be applied to seals or filler materials between precast segments and other elements (for example, fluid conduits). In various example embodiments, one or more nanotech coatings may be applied to seals or filler materials between spaces or filler material within precast forms. In various example embodiments, one or more nanotech coatings may be applied to seals or filler materials associated with a powerhouse or dam.

The teachings of all patents, published applications, and references cited herein are incorporated by reference in their entirety.

The elements shown and described in the figures may not be to scale. In some embodiments, the features shown and/or described may have a different size and/or shape. The embodiments described herein may include one or more of the elements and/or characteristics described in connection with another embodiment shown or described herein.

While example embodiments have been particularly shown and described, it will be understood by those skilled in the art that various changes in form and details may be made therein without departing from the scope of the embodiments encompassed by the appended claims.

1. A hydro power generation system, comprising:
a powerhouse including an intake port, a draft port, and a power generator disposed therebetween, the power generator configured to generate electrical power as a function of fluid flow between the intake port and draft port, the powerhouse, during operation of the power generator, in fluidic communication with a natural run-of-the-river portion of a waterway via the intake port and the draft port, with the fluid flow therebetween distinct from the natural run-of-the-river portion of the waterway; and
an entrance region structure coupled to the powerhouse and defining a portion of a boundary of an entrance region and the natural run-of-the-river portion of the waterway, the entrance region being distinct from the natural run-of-the-river portion of the waterway and fluidically adjacent to the intake port, the entrance region structure being upstream relative to the intake port.

2. The power generation system of claim 1, further comprising an entrance region operational support system configured to enable at least one of aquatic life, fluid volume, debris, ice, temperature, or water flow direction in the entrance region to be managed.

3. The power generation system of claim 2, wherein the powerhouse is one or multiple powerhouses and the entrance region operational support system coordinates communication between the multiple powerhouses.

4. The power generation system of claim 2, wherein the entrance region operational support system is enabled to be controlled remotely.

5. The power generation system of claim 2, wherein the entrance region operational support system comprises an attraction system configured attract aquatic life in the waterway toward the natural run-of-the-river portion of the waterway.

6. The power generation system of claim 5, wherein at least one of the at least one attraction system comprises a gas infusion system, and wherein the gas infusion system is configured to increase the amount of oxygen in the natural run-of-the-river portion of the waterway or at an opposing side of the natural run-of-the-river waterway from a location of the entrance region of the powerhouse.

7. The power generation system of claim 5, wherein the at least one attraction system is configured to decrease the amount of nitrogen and/or trace gases in the natural run-of-the-river portion of the waterway or at an opposing side of the natural run-of-the-river waterway from a location of an entrance region of the powerhouse.

8. The power generation system of claim 5, wherein the powerhouse is arranged at one side of the waterway and the attraction system is arranged at an opposing side of the waterway such that the natural run-of-the-river portion of the waterway is between the powerhouse and the attraction system.

9. The power generation system of claim 5, wherein the attraction system is positioned upstream from an entrance region to the powerhouse.

10. The power generation system of claim 5, wherein the attraction system is deployed within 500 feet of the powerhouse.

11. The power generation system of claim 2, wherein the entrance region operational support system further comprises at least one deterrence system known to deter aquatic life and located at least a portion of or upstream of a perimeter of the entrance region to the powerhouse, and wherein the deterrence system is configured to be selectively opened and closed or activated and deactivated.

12. The power generation system of claim 1, wherein the entrance region structure is an entrance region direction wall that defines at least a portion of a perimeter of the entrance region, the entrance region direction wall separating the entrance region from the natural run-of-the river portion of the waterway.

13. The power generation system of claim 12, wherein the entrance region direction wall comprises at least two precast segments interconnected to each other.

14. The power generation system of claim 12, further comprising at least one flood control gate mounted at the entrance region direction wall.

15. The power generation system of claim 12, wherein the entrance region direction wall defines a port configured to allow access from the entrance region to the natural run-of-the-river portion of the waterway.

16. The power generation system of claim 15, further comprising a port cover coupled to the entrance region direction wall and arranged to restrict fluidic access through the port in a selectable manner.

17. The power generation system of claim 12, wherein the entrance region has an opening at least partially defined by the entrance region direction wall.

18. The power generation system of claim 12, further comprising an exit region direction wall that defines at least a portion of a perimeter of an exit region from the powerhouse.

19. The power generation system of claim 12, wherein the entrance region direction wall comprises an adjustable intake arm that extends upstream from the entrance region direction wall.

20. The power generation system of claim 19, wherein the entrance region operational support system is configured to control the adjustable intake arm.

21. The power generation system of claim 20, further comprising a water height sensor configured to communicate with the entrance region operational support system, the entrance region operational support system being configured to control the adjustable intake arm in response to signals from the water height sensor.

22. The power generation system of claim 19, wherein the adjustable intake arm is coupled to a track and is constructed and arranged to be controllably moved along the track, thereby adjusting access to or flow of fluid into the entrance region.

23. The power generation system of claim 19, wherein the adjustable intake arm comprises at least two precast segments interconnected to each other.

24. The power generation system of claim 1, wherein a river-facing side of the entrance region support structure and a river-facing side of the powerhouse are composed of precast segments.

25. The power generation system of claim 24, wherein, at an intersection between the powerhouse and the entrance region support structure, a precast segment from the powerhouse is adjacent to a precast segment of the entrance region support structure.

26. The power generation system of claim 1, wherein the powerhouse comprises multiple intake ports and respective multiple draft ports and further comprises at least one intake control gate configured to restrict access to a corresponding intake port.

27. The power generation system of claim 1, wherein the powerhouse comprises at least two precast segments interconnected to each other.

28. The power generation system of claim 1, wherein the powerhouse is positioned in the middle of the waterway, and the natural run-of-the-river portion is between the powerhouse and at least one edge of the waterway.

29. A method of operating a hydro power generation system, comprising:
monitoring a level of fluid volume at an entrance region of a powerhouse, the entrance region being distinct from a natural run-of-the-river portion of a waterway, the entrance region being upstream of and fluidically adjacent to an intake port of the powerhouse; and
adjusting one or more elements of an entrance region operational support system in response to the level of fluid volume in the entrance region being at or above a fluid threshold level.

30. The method of claim 29, wherein at least two of the one or more elements of the entrance region operational support system are associated with different powerhouses.
